(19) United States
(12) Patent Application Publication
(10) Pub. No.: US 2023/0216637 A1
(43) Pub. Date: Jul. 6, 2023

(54) COMMUNICATION DEVICE

(71) Applicant: SONY GROUP CORPORATION, TOKYO (JP)

(72) Inventor: KEN TANAKA, TOKYO (JP)

(21) Appl. No.: 17/999,852

(22) PCT Filed: May 27, 2021
(86) PCT No.: PCT/JP2021/020124

§ 371 Date: Dec. 13, 2022

(30) Foreign Application Priority Data
Jun. 10, 2020 (JP) 2020-101074

(51) Int. Cl. H04L 5/00; H04W 16/28

(52) U.S. Cl. CPC H04L 5/0051; H04W 16/28

(57) ABSTRACT

The present technology relates to a communication device enabling to suppress deterioration of communication quality. Provided is a communication device that is a first communication device including one or more antennas, and the communication device includes a control unit configured to perform control of: generating first information on the basis of a reference signal transmitted from a second communication device including one or more antennas, the first information including information regarding an arrival time of the reference signal and information indicating that information regarding the arrival time is included, for each combination of the antennas included in the first communication device and the second communication device; and transmitting the generated first information to the second communication device. The present technology can be applied to, for example, a device constituting a wireless LAN system.

### TECHNICAL FIELD

The present technology relates to a communication device, and particularly to a communication device capable of suppressing deterioration of communication quality.

### BACKGROUND ART

In recent years, with the spread of wireless local area network (LAN) systems, advancement of wireless communication terminals and diversification of communication applications have progressed, and there is a demand for expansion of communication capacity to the wireless communication terminals. For example, Patent Document 1 discloses a technology related to cooperation of a receiving station for satellite communication using multiple-input and multiple-output (MIMO).

In general, since a spatial attenuation amount is large in a high frequency band, a technique of obtaining a high gain and compensating for spatial attenuation by an array antenna on which a large number of antenna elements are mounted has been adopted. In the array antenna, in a transmitter and a receiver, a high gain can be obtained by analog beamforming in which signals of individual array antenna elements are synthesized by an analog circuit. Analog beamforming can generally be performed using phased array antennas.

### CITATION LIST

### Patent Document

Patent Document 1: Japanese Patent Application Laid-Open No. 2017-41792

### SUMMARY OF THE INVENTION

### Problems to be Solved by the Invention

However, in a case where a baseband signal is used in broadband transmission, even if there is no frequency characteristic in a propagation path, an equal gain cannot be obtained in a band due to beamforming of the phased array antenna, and there is a possibility that communication quality is deteriorated.

The present technology has been made in view of such a situation, and an object thereof is to suppress deterioration of communication quality.

### Solutions to Problems

There is provided a communication device of one aspect of the present technology that is a first communication device including one or more antennas, the communication device including a control unit configured to perform control of: generating first information on the basis of a reference signal transmitted from a second communication device including one or more antennas, the first information including information regarding an arrival time of the reference signal and information indicating that information regarding the arrival time is included, for each combination of the antennas included in the first communication device and the second communication device; and transmitting the generated first information to the second communication device.

A communication device according to one aspect of the present technology is a first communication device including one or more antennas, in which first information is generated on the basis of a reference signal transmitted from a second communication device including one or more antennas, the first information including information regarding an arrival time of the reference signal and information indicating that information regarding the arrival time is included, for each combination of the antennas included in the first communication device and the second communication device, and the generated first information is transmitted to the second communication device.

A communication device according to one aspect of the present technology is a communication device that is a first communication device including one or more antennas, the communication device including a control unit configured to perform control of: estimating a propagation path with a second communication device on the basis of a reference signal transmitted from the second communication device including one or more antennas, and generating fourth information indicating a request for transmitting the reference signal obtained by computing a delay time vector in each of the antennas of the second communication device, the delay time vector being any minute delay time difference computed by each of the antennas; and transmitting the generated fourth information to the second communication device.

A communication device according to one aspect of the present technology is a first communication device including one or more antennas, in which a propagation path with a second communication device is estimated on the basis of a reference signal transmitted from the second communication device including one or more antennas, and fourth information is generated indicating a request for transmitting the reference signal obtained by computing a delay time vector that is any minute delay time difference computed by each of the antennas, in each of the antennas of the second communication device, and the generated fourth information is transmitted to the second communication device.

A communication device according to one aspect of the present technology is a communication device that is a third communication device including one or more antennas, the communication device including a control unit configured to perform control of transmitting, to a fourth communication device including one or more antennas, a reference signal including one or more reference signal elements with respect to a reference signal element generated on the basis of a delay time vector.

A communication device according to one aspect of the present technology is a third communication device including one or more antennas, in which, with respect to a reference signal element generated on the basis of a delay time vector, a reference signal including one or more reference signal elements is transmitted to a fourth communication device including one or more antennas.

Note that the communication device according to one aspect of the present technology may be an independent device or an internal block constituting one device.

### BRIEF DESCRIPTION OF DRAWINGS

FIG. 1 is a view illustrating a configuration example of a wireless network system to which the present technology is applied.

FIG. 2 is a diagram illustrating a first example of a configuration of a communication device to which the present technology is applied.

FIG. 3 is a diagram illustrating a second example of the configuration of the communication device to which the present technology is applied.

FIG. 4 is a diagram illustrating a third example of the configuration of the communication device to which the present technology is applied.

FIG. 5 is a diagram illustrating a fourth example of the configuration of the communication device to which the present technology is applied.

FIG. 6 is a view illustrating a first example of an entire sequence of the present technology.

FIG. 7 is a view illustrating a configuration example of a frame notification of which is provided in Capabilities Exchange.

FIG. 8 is a view illustrating a configuration example of a frame notification of which is provided in Enhanced-MIMO BF setup.

FIG. 9 is a view illustrating a configuration example of a frame notification of which is provided in Beam Training.

FIG. 10 is a view illustrating an example of a transmission timing of E-BRP in Beam Training.

FIG. 11 is a view illustrating a configuration example of TRN-B.

FIG. 12 is a view illustrating a configuration example of a frame notification of which is provided in Enhanced-MIMO BF Feedback.

FIG. 13 is a view illustrating a configuration example of a frame notification of which is provided in Enhanced-MIMO BF Feedback.

FIG. 14 is a view illustrating a second example of the entire sequence of the present technology.

FIG. 15 is a view illustrating a configuration example of a frame notification of which is provided in Enhanced-MIMO BF Feedback.

FIG. 16 is a view illustrating a configuration example of a frame notification of which is provided in Enhanced-MIMO BF Request.

FIG. 17 is a view illustrating a configuration example of a frame notification of which is provided in Enhanced-MIMO BF Announcement.

### MODE FOR CARRYING OUT THE INVENTION

### 1. First Embodiment

In recent years, with advancement of wireless communication terminals and diversification of communication applications, there is a demand for expansion of communication capacity to the wireless communication terminals.

In general, since a spatial attenuation amount is large in a high frequency band, a technique of obtaining a high gain and compensating for spatial attenuation by an array antenna on which a large number of antenna elements are mounted has been adopted. In the array antenna, in a transmitter and a receiver, a high gain can be obtained by analog beamforming in which signals of individual array antenna elements are synthesized by an analog circuit (a radio frequency (RF) circuit).

In the analog beamforming, there is a true delay line (TDL) method in which a delay line is mounted for every antenna element, but it is required to increase a circuit scale and to improve precision of implementation due to the mounting of the delay line. Whereas, there is a phased array antenna in which a phase shifter is mounted on each element. The phased array antenna is easy to implement as compared with the TDL, and can suppress enlargement of a circuit scale. For this reason, the phased array antenna is generally used in a 60 GHz band.

However, since the phase shifter multiplies by a complex phase common to frequencies, even if the phase shifter applies optimum analog beamforming for a certain desired frequency, optimum beamforming cannot be applied for other frequencies. That is, in the phased array antenna, it is not possible to perform beamforming with equal directional gains in the same direction for all frequencies.

This is particularly noticeable in a case where a time during which a radio wave propagates a path length difference between a transmission antenna and a reception antenna cannot be ignored with respect to a period of a baseband frequency band. For this reason, in a case where a broadband baseband signal is used, even if there is no frequency characteristic in a propagation path, equal gain cannot be obtained in a band due to beamforming of the phased array antenna, and there arises a problem of degradation of the communication quality.

In Document 1 below, the phenomenon described above is referred to as a spatial-wideband effect, and is referred to as a problem that occurs particularly in an array antenna having a wide opening length.
Document 1: Bolei Wang, et al., “Spatial-Wideband Effect in Massive MIMO with Application inmmWave Systems,” IEEE Communications Magazine, Vol. 56, Issue 12, December 2018

In the spatial-wideband effect, characteristics are determined by an opening length of an antenna (or the number of elements of an array antenna), an arrival angle and a radiation angle of a radio wave, a bandwidth, and the like, and a variation in gain in a band tends to be larger as these parameter values are larger. This is because, even in one array antenna, a large number of delay waves having equal intensity are observed to arrive due to an increase in path length difference between a plurality of elements due to the wide opening length or a wavelength reduction due to a higher frequency of a baseband signal.

In general, in a linear array antenna, in a case where the condition represented by the following Equation (1) is not satisfied, the spatial-wideband effect remarkably appears.

$$\begin{matrix}[ Formula 1 ] & \\ τ ≪ \frac{T}{2 π} , … … s . t . τ = \cdot \frac{m Δ d sin θ}{c} & ( 1 )\end{matrix}$$

Note that, in Equation (1), m is the number of antenna elements of the linear array antenna, d is an antenna element interval (m) of the linear array antenna, θ is an incident angle or a radiation angle (rad) of a radio wave in the linear array antenna, c is a light flux (m/s), and T is a period (s) of a baseband frequency. In these specifications, τ represents a maximum delay time difference (s) to be received/transmitted between the antenna elements of the linear array antenna.

Here, a compensation method for the spatial-wideband effect and necessity of sounding for compensation will be described.

In order to compensate for the spatial-wideband effect, the TDL method is desirable, but a method in which the TDL method and the phased array antenna are combined can be considered as a practical solution.

Specifically, while the phased array antenna is segmented into sub-arrays having a size that can suppress the spatial-wideband effect, and analog beamforming is performed for every divided sub-array, this is a method of multiplying different delay times in a time domain or different weight coefficients in a frequency domain between the sub-arrays.

At this time, the weight coefficients multiplied between the sub-arrays may be computed in a baseband, which can be performed by hybrid beamforming. Similarly to the spatial-wideband effect, the weighting coefficient described above varies depending on an antenna opening length, an arrival angle, a radiation angle, and a bandwidth, and thus it is necessary to estimate a propagation path. Generally, in the propagation path estimation, a transmitter performs transmission (sounding) of a known sequence to a receiver, and the receiver estimates a propagation path on the basis of a reception result of the known sequence and feeds back an estimation result to the transmitter.

Furthermore, a difference in feedback of propagation path estimation according to a modulation scheme will be described. A feedback format of a propagation path estimation result varies depending on the modulation scheme. For example, a weight coefficient can be multiplied in the frequency domain in an orthogonal frequency domain multiplexing (OFDM) modulation scheme, in the single carrier (SC) transmission scheme. Whereas, in a case where arithmetic processing in the time domain is a prerequisite, computation is limited to be in the time domain, not in the frequency domain. Therefore, while feedback of propagation path estimation is performed in the frequency domain in the OFDM modulation scheme, feedback of propagation path estimation is performed in the time domain in the SC transmission scheme.

In these feedbacks, while propagation path estimation results for any given frequencies are required in the feedback in the frequency domain, a propagation path estimation result within a maximum delay time assumed in a propagation environment is required in the feedback in the time domain. However, since a propagation loss and a diffraction loss of a radio wave are large in a high frequency band, the number of paths of the propagation path tends to be small. For this reason, the feedback in the time domain tends to have a smaller amount of information than the feedback in the frequency domain, and the feedback can be performed even with a time response of several taps. In general, one tap representing a unit time of a time response is a sample time.

As described above, since the number of paths of the propagation path tends to be small in a high frequency band, the high frequency band tends to be used particularly in a line-of-sight environment. Document 2 below describes that propagation path information of a preceding wave is fed back, but propagation path information of a direct wave having a high channel gain is to be fed back in a line-of-sight environment.
Document 2: Assaf Kasher, et al., “First Path BF text,” doc.: IEEE 802/11-17/1436r1 2017

As a result, overhead for performing analog beamforming or hybrid beamforming in which analog beamforming and digital signal processing of a baseband signal are combined can be shortened.

However, in a case where the spatial-wideband effect occurs, it is necessary that the number of taps of the feedback time response is large in order to obtain information for compensating for the spatial-wideband effect, even in a line-of-sight environment.

In a case where the spatial-wideband effect occurs, the number of taps of the feedback time response needs to be large in order to obtain information for compensating for the spatial-wideband effect even in a line-of-sight environment. That is, this is because it is necessary to obtain τ with a resolution higher than a period (or a sampling period) of the baseband frequency, while characteristics of the spatial-wideband effect can be estimated by obtaining τ as indicated by the Equation (1) described above. That is, it is necessary to acquire a time response in which a time unit shorter than the sample time is one tap.

Meanwhile, in a wireless local area network (LAN), IEEE 802.11ad is established as a communication standard of a 60 GHz band, and techniques such as broadband transmission of about 4 GHz band or more, hybrid beamforming, and multiple-input and multiple-output (MIMO) have been studied in task group (TG)ay, in order to further increase a capacity. In the broadband transmission, particularly, when the OFDM modulation scheme is used, a peak-to-average power ratio (PAPR) tends to be high because the number of subcarriers is large. Therefore, an SC transmission scheme capable of relatively suppressing the PAPR is attracting attention.

However, as in Document 3 below, in a case where a propagation path estimation result fed back at a time of performing hybrid beamforming with the SC transmission scheme is fed back with a period of a bandwidth at a frequency of a baseband as one tap, in an environment where the spatial-wideband effect remarkably appears as described above, a feedback amount is to be increased, or otherwise transmission is performed without compensation for an influence of the spatial-wideband effect. Therefore, there is a problem that an effective rate decreases in any cases.
Document 3: Kome Oteri, et al., “Hybrid Beamforming Feedback in 802.11ay,” doc.: IEEE 802.11-18/0192r1 2018

Therefore, in the present technology, a feedback technique is proposed in which an information amount is reduced even in a case where a spatial-wideband effect occurs. This technique enables effective throughput to be improved even in a case where the spatial-wideband effect remarkably occurs, so that deterioration of communication quality can be suppressed. Hereinafter, embodiments of the present technology will be described with reference to the drawings.

(System Configuration)

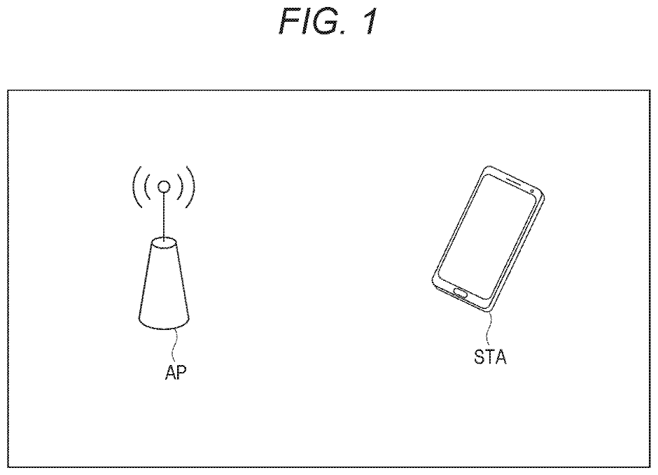

FIG. 1 illustrates a configuration example of a wireless LAN system, as a wireless network system to which the present technology is applied.

In FIG. 1, a configuration is adopted in which one access point AP and a communication terminal STA are connected to each other, and the access point AP performs single user-MIMO (SU-MIMO) transmission to the communication terminal STA. That is, the access point AP transmits a plurality of streams to the communication terminal STA.

Although only one communication terminal STA is illustrated in FIG. 1, a plurality of communication terminals STA may be provided in a case where the access point AP can simultaneously communicate with a plurality of communication terminals STA by using frequency division or the like.

### First Example of Device Configuration

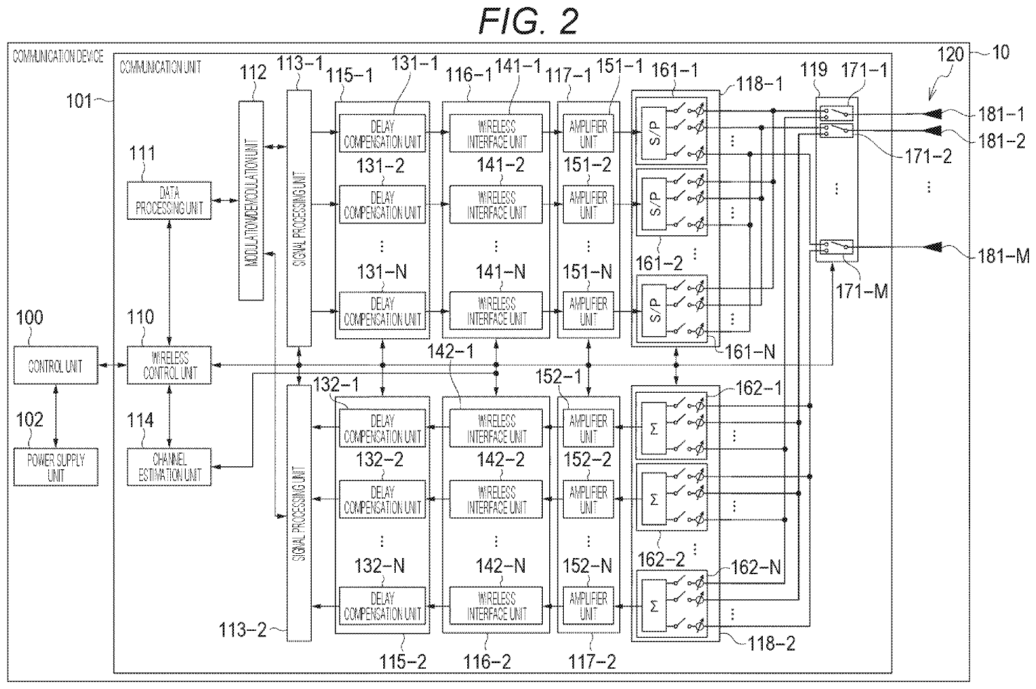

FIG. 2 illustrates a first example of a configuration of a communication device to which the present technology is applied.

A communication device 10 illustrated in FIG. 2 is configured as the access point AP or the communication terminal STA in the wireless network system of FIG. 1. That is, a basic configuration is similar between the access point AP and the communication terminal STA.

In FIG. 2, the communication device 10 includes a control unit 100, a communication unit 101, and a power supply unit 102. Furthermore, in the communication device 10 of FIG. 2, an antenna unit 120 is provided for (a SW unit 119 of) the communication unit 101. The communication unit 101 may be realized by LSI.

In the communication device 10 of FIG. 2, the communication unit 101 includes a wireless control unit 110, a data processing unit 111, a modulation/demodulation unit 112, signal processing units 113-1 and 113-2, a channel estimation unit 114, additional delay compensation units 115-1 and 115-2, wireless interface units 116-1 and 116-2, amplifier units 117-1 and 117-2, phase shifter units 118-1 and 118-2, and the SW unit 119.

The control unit 100 includes a microprocessor or the like, and controls operation of each unit of the communication device 10. The control unit 100 controls the wireless control unit 110 and the power supply unit 102. Furthermore, the control unit 100 may perform at least a part of operation of the wireless control unit 110 instead of the wireless control unit 110.

The wireless control unit 110 exchanges information (data) between individual units. Furthermore, the wireless control unit 110 performs packet scheduling in the data processing unit 111, and parameter setting in the modulation/demodulation unit 112 and the signal processing units 113-1 and 113-2. Furthermore, the wireless control unit 110 performs parameter setting and transmission power control in the wireless interface units 116-1 and 116-2 and the amplifier units 117-1 and 117-2.

The data processing unit 111 generates a packet for wireless communication from input data at a time of transmission when data is inputted from an upper layer, performs processing such as addition of a header for media access control (MAC) and addition of an error detection code, and supplies processing data obtained as a result thereof to the modulation/demodulation unit 112.

Furthermore, the data processing unit 111 performs processing such as analysis of a MAC header, detection of a packet error, and reorder processing on input data at a time of reception when data is inputted from the modulation/demodulation unit 112, and outputs processing data obtained as a result thereof to a protocol upper layer.

At a time of transmission, on the basis of an encoding scheme, a modulation scheme, and the like set by the wireless control unit 110, the modulation/demodulation unit 112 performs processing such as encoding, interleaving, and modulation on input data inputted from the data processing unit 111, and outputs data symbol stream obtained as a result thereof to the signal processing unit 113-1.

Furthermore, at a time of reception, on the basis of a demodulation scheme, a decoding scheme, and the like set by the wireless control unit 110, the modulation/demodulation unit 112 performs, on the data symbol stream inputted from the signal processing unit 113-2, processing opposite to that at the time of transmission, that is, processing such as demodulation, deinterleaving, and decoding, and outputs processing data obtained as a result thereof to the data processing unit 111.

At a time of transmission, the signal processing unit 113-1 performs processing such as signal processing to be used for spatial separation as necessary on the data symbol stream inputted from the modulation/demodulation unit 112, and outputs one or more transmission symbol streams obtained as a result thereof to the additional delay compensation unit 115-1.

At a time of reception, the signal processing unit 113-2 performs processing such as signal processing for spatial decomposition of a stream as necessary on the reception symbol stream inputted from the additional delay compensation unit 115-2, and outputs data symbol stream obtained as a result thereof to the modulation/demodulation unit 112.

The channel estimation unit 114 calculates complex channel gain information of a propagation path from a preamble portion and a training signal portion of an input signal from the wireless interface unit 116-2. The complex channel gain information calculated by the channel estimation unit 114 is used for demodulation processing in the modulation/demodulation unit 112 and spatial processing in the signal processing units 113-1 and 113-2, via the wireless control unit 110.

The additional delay compensation units 115-1 and 115-2 apply a delay amount determined by the wireless control unit 110 for the every connected wireless interface units 116-1 and 116-2. One wireless interface unit 116 is connected to a plurality of antennas via the amplifier unit 117 and the phase shifter unit 118. Therefore, the additional delay compensation unit 115 can collectively apply a same delay amount to a plurality of antennas rather than for each antenna.

In the additional delay compensation unit 115-1, delay compensation units 131-1 to 131-N (N: an integer of 1 or more) are provided for every sequence according to the antenna, and a same delay amount can be collectively applied. Furthermore, in the additional delay compensation unit 115-2, delay compensation units 132-1 to 132-N are provided for every sequence according to the antenna, and a same delay amount can be collectively applied.

At a time of transmission, the wireless interface unit 116-1 converts a transmission symbol stream inputted from the additional delay compensation unit 115-1 into an analog signal, performs processing such as filtering, up-conversion to a carrier wave frequency, and phase control, and outputs a transmission signal obtained as a result thereof to the amplifier unit 117-1.

At a time of reception, the wireless interface unit 116-2 performs processing opposite to that at the time of transmission, that is, processing such as down-conversion on the reception signal inputted from the amplifier unit 117-2, and outputs a reception symbol stream obtained as a result thereof to the additional delay compensation unit 115-2. Furthermore, the wireless interface unit 116-2 outputs data obtained by the processing to the channel estimation unit 114.

In the wireless interface unit 116-1, wireless interface units 141-1 to 141-N are provided for every sequence, and the above-described processing at the time of transmission is individually applied. Furthermore, in the wireless interface unit 116-2, wireless interface units 142-1 to 142-N are provided for every sequence, and the above-described processing at the time of reception is applied.

At a time of transmission, the amplifier unit 117-1 amplifies an analog signal, which is a transmission signal inputted from the wireless interface unit 116-1, up to predetermined power, and outputs the analog signal to the phase shifter unit 118-1. Furthermore, at a time of reception, the amplifier unit 117-2 amplifies an analog signal, which is a reception signal inputted from the phase shifter unit 118-2, up to predetermined power, and outputs the analog signal to the wireless interface unit 116-2.

In the amplifier unit 117-1, amplifier units 151-1 to 151-N are provided for every sequence, and signals are individually amplified. Furthermore, in the amplifier unit 117-2, amplifier units 152-1 to 152-N are provided for every sequence, and signals are individually amplified.

The phase shifter units 118-1 and 118-2 perform phase shift adjustment (hereinafter, referred to as an antenna weight vector (AWV) or a sector) on a phase shifter connected to each antenna.

At a time of transmission, the phase shifter unit 118-1 performs serial-to-parallel (S/P) conversion on a transmission signal such that signals can be transmitted in parallel to an antenna that is a signal transmission target. Thereafter, complex phase control according to each antenna is performed, and the signal is outputted to the SW unit 119. As illustrated in the configuration of FIGS. 2, rather than all the connected antennas, the transmission target antenna can be limited, for example, by providing a switch inside the phase shifter unit 118-1.

At a time of reception, the phase shifter unit 118-2 performs complex phase according to every antenna for a signal inputted from each antenna to synthesize a reception signal, and then outputs the reception signal to the amplifier unit 117-2. As illustrated in the configuration of FIG. 2, for example, by providing a switch inside the phase shifter unit 118-2, only reception signals from some limited antennas may be synthesized, instead of synthesizing input signals from all the antennas.

In the phase shifter unit 118-1, phase shifter units 161-1 to 161-N are provided for every sequence, and processing such as complex phase control is individually applied. Furthermore, in the phase shifter unit 118-2, phase shifter units 162-1 to 162-N are provided for every sequence, and processing such as complex phase control is individually applied.

The SW unit 119 switches a circuit to which the antenna unit 120 is connected, in accordance with transmission or reception of the antenna. The SW unit 119 includes switches 171-1 to 171-M, and a connection destination of each switch is switched in accordance with transmission or reception of an antenna. The antenna unit 120 includes antennas 181-1 to 181-M. Here, M is an integer of 1 or more, and the antenna unit 120 includes one or more antennas.

Note that, hereinafter, in a case where it is not necessary to particularly distinguish from each other, the signal processing units 113-1 and 113-2, the additional delay compensation units 115-1 and 115-2, the wireless interface units 116-1 and 116-2, the amplifier units 117-1 and 117-2, and the phase shifter units 118-1 and 118-2 are referred to as a signal processing unit 113, an additional delay compensation unit 115, a wireless interface unit 116, an amplifier unit 117, and a phase shifter unit 118.

Furthermore, in the amplifier unit 117, (at least a part of) at least one of the function at the time of transmission or the function at the time of reception may be included in the wireless interface unit 116. Furthermore, in the amplifier unit 117, (at least a part of) at least one of the function at the time of transmission or the function at the time of reception may be a component external to the communication unit 101. Moreover, one or more sets of the wireless interface unit 116, the amplifier unit 117, the antenna unit 120, and the like may be included as a component.

The power supply unit 102 includes a battery power supply, a fixed power supply, or the like. The power supply unit 102 supplies power to each unit of the communication device 10 under control of the control unit 100.

### Second Example of Device Configuration

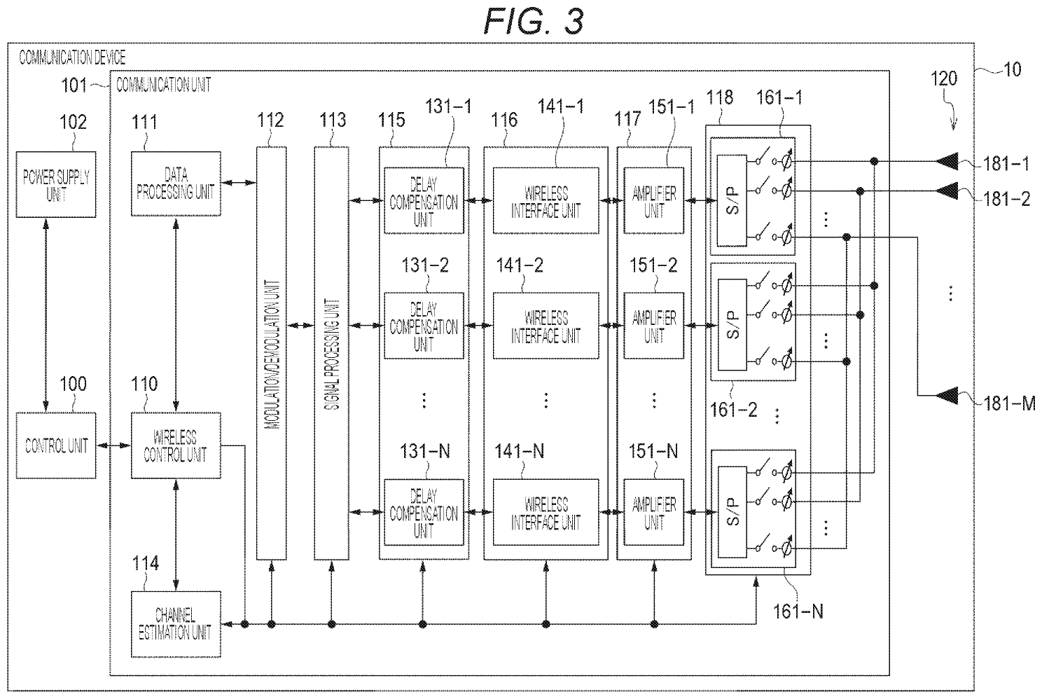

FIG. 3 illustrates a second example of the configuration of the communication device to which the present technology is applied.

The communication device 10 illustrated in FIG. 3 is configured as the access point AP or the communication terminal STA in the wireless network system of FIG. 1.

In the communication device 10 of FIG. 3, the same or corresponding parts as those of the communication device 10 of FIG. 2 are denoted by the same reference numerals, and a description of these parts will be omitted as appropriate because the description will be redundant.

In FIG. 3, the communication device 10 includes the control unit 100, the communication unit 101, and the power supply unit 102. Furthermore, in the communication device 10, the antenna unit 120 is provided for (the phase shifter unit 118 of) the communication unit 101. The communication unit 101 may be realized by LSI.

In FIG. 3, as compared with the communication unit 101 in FIG. 2, the communication unit 101 is similar in that the wireless control unit 110, the data processing unit 111, the modulation/demodulation unit 112, the signal processing unit 113, the channel estimation unit 114, the additional delay compensation unit 115, the wireless interface unit 116, the amplifier unit 117, and the phase shifter unit 118 are included, but is different in that the SW unit 119 is not present and the antenna unit 120 is shared in transmission and reception.

In FIG. 3, the signal processing unit 113, the additional delay compensation unit 115, the wireless interface unit 116, the amplifier unit 117, and the phase shifter unit 118 individually perform processing at the time of transmission and at the time of reception. Note that, one or more sets of the wireless interface unit 116, the amplifier unit 117, the antenna unit 120, and the like may be included as a component. Furthermore, the function of the amplifier unit 117 may be included in the wireless interface unit 116.

### Third Example of Device Configuration

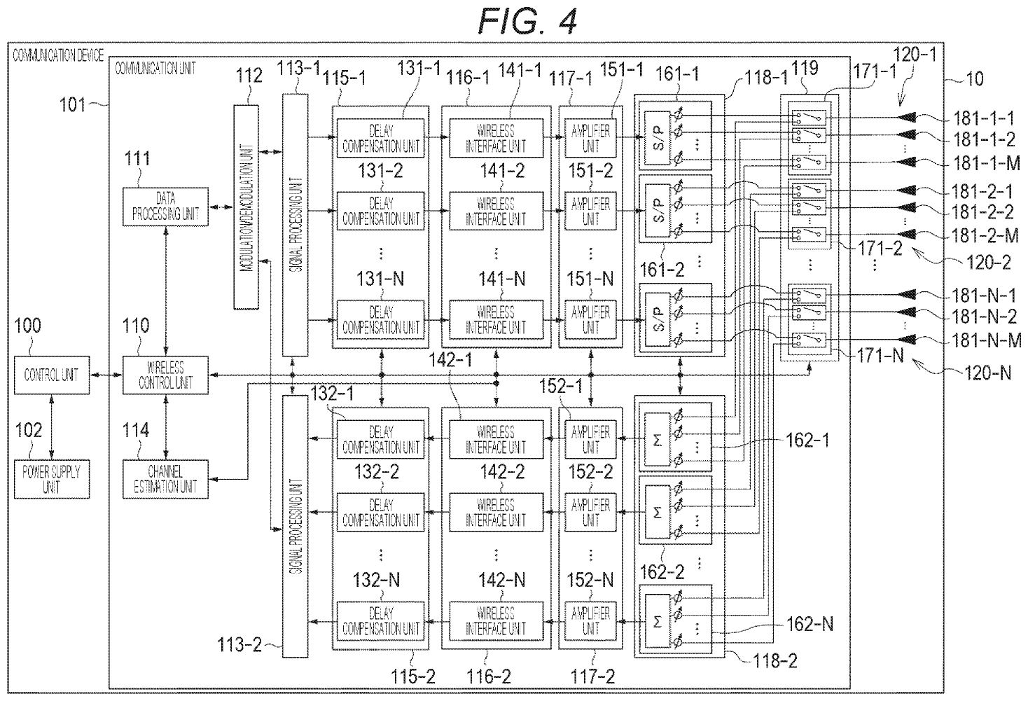

FIG. 4 illustrates a third example of the configuration of the communication device to which the present technology is applied.

The communication device 10 illustrated in FIG. 4 is configured as the access point AP or the communication terminal STA in the wireless network system of FIG. 1.

In the communication device 10 of FIG. 4, the same or corresponding parts as those of the communication device 10 of FIGS. 2 and 3 are denoted by the same reference numerals, and a description of these parts will be omitted as appropriate because the description will be redundant.

In FIG. 4, the communication device 10 includes the control unit 100, the communication unit 101, and the power supply unit 102. Furthermore, in the communication device 10, antenna units 120-1 to 120-N are provided for (the SW unit 119 of) the communication unit 101. The communication unit 101 may be realized by LSI.

In FIG. 4, as compared with the communication unit 101 in FIG. 2, the communication unit 101 is similar in that the wireless control unit 110, the data processing unit 111, the modulation/demodulation unit 112, the signal processing units 113-1 and 113-2, the channel estimation unit 114, the additional delay compensation units 115-1 and 115-2, the wireless interface units 116-1 and 116-2, the amplifier units 117-1 and 117-2, the phase shifter units 118-1 and 118-2, and the SW unit 119 are included, but is different in the number of antennas of the antenna units 120-1 to 120-N connected to the phase shifter units 118-1 and 118-2 via the SW unit 119.

For example, the antenna unit 120-1 includes antennas 181-1-1 to 181-1-M. Furthermore, the antenna unit 120-2 includes antennas 181-2-1 to 181-2-M. Note that the antenna unit 120-N includes antennas 181-N-1 to 181-N-M (N, M: an integer of 1 or more) although details are omitted because the description will be redundant.

Note that one or more sets of the wireless interface unit 116, the amplifier unit 117, and the antenna unit 120 may be included as a component. Furthermore, the function of the amplifier unit 117 may be included in the wireless interface unit 116.

### Fourth Example of Device Configuration

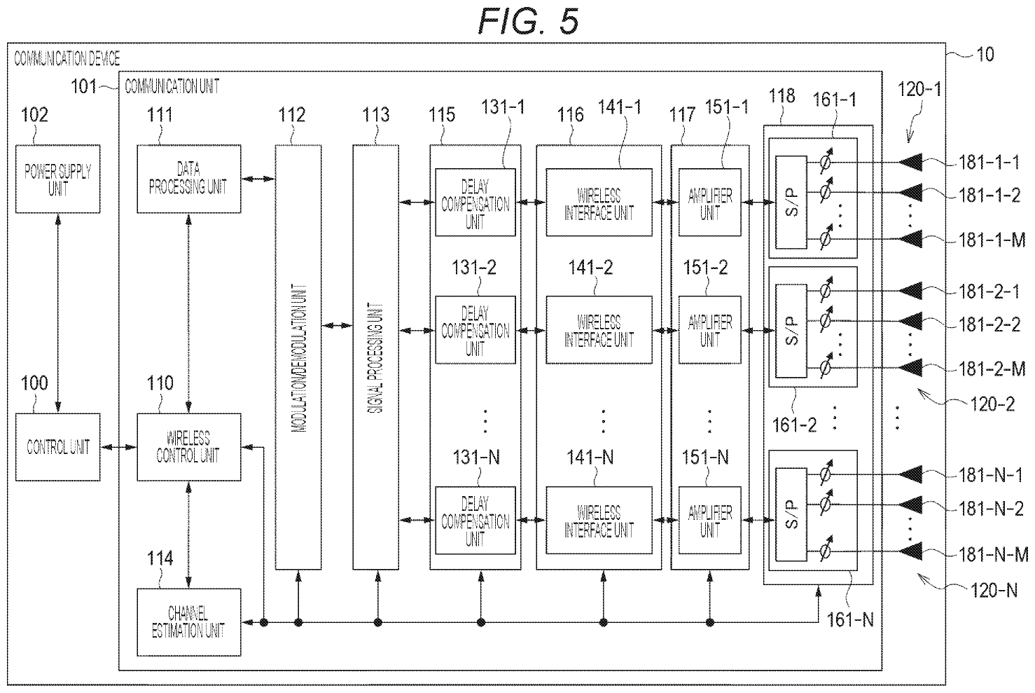

FIG. 5 illustrates a fourth example of the configuration of the communication device to which the present technology is applied.

The communication device 10 illustrated in FIG. 5 is configured as the access point AP or the communication terminal STA in the wireless network system of FIG. 1.

In the communication device 10 of FIG. 5, the same or corresponding parts as those of the communication device 10 of FIGS. 2 to 4 are denoted by the same reference numerals, and a description of these parts will be omitted as appropriate because the description will be redundant.

In FIG. 5, the communication device 10 includes the control unit 100, the communication unit 101, and the power supply unit 102. Furthermore, in the communication device 10, the antenna units 120-1 to 120-N are provided for (the phase shifter unit 118 of) the communication unit 101. The communication unit 101 may be realized by LSI.

In FIG. 5, as compared with the communication unit 101 in FIG. 2, the communication unit 101 is similar in that the wireless control unit 110, the data processing unit 111, the modulation/demodulation unit 112, the signal processing unit 113, the channel estimation unit 114, the additional delay compensation unit 115, the wireless interface unit 116, the amplifier unit 117, and the phase shifter unit 118 are included, but is different in that the SW unit 119 is not present and the antenna units 120-1 to 120-N are shared in transmission and reception.

Furthermore, when the communication unit 101 in FIG. 5 is compared with the communication unit 101 in FIG. 3, the number of antennas connected to the phase shifter unit 118, that is, the number of antennas of the antenna units 120-1 to 120-N in FIG. 5 is different from the number of antennas of the antenna unit 120 in FIG. 3.

Note that, one or more sets of the wireless interface unit 116, the amplifier unit 117, the antenna unit 120, and the like may be included as a component. Furthermore, the function of the amplifier unit 117 may be included in the wireless interface unit 116.

In any of the configurations of the communication device 10 described with reference to FIGS. 2 to 5, the phase shifter unit 118 has a block unit for every S/P or Z. In the following description, an antenna connected to these units is referred to as a directional multi gigabit (DMG) antenna, and a coefficient used in signal processing to be used for spatial separation in the signal processing unit 113 is referred to as precoding or steering of matrix.

(Overall Sequence)

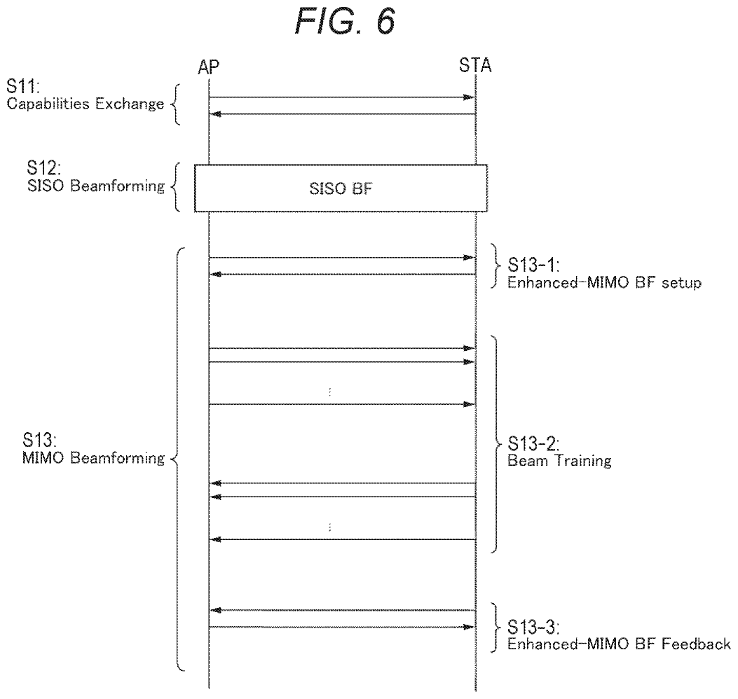

FIG. 6 illustrates a first example of an entire sequence of the present technology. In FIG. 6, similarly to the wireless network system of FIG. 1, it is assumed that there is one access point AP and one communication terminal STA.

As illustrated in FIG. 6, three steps of Capabilities Exchange (S11), SISO Beamforming (S12), and MIMO Beamforming (S13) are performed between the access point AP and the communication terminal STA. In particular, in MIMO Beamforming (S13), three sub-steps of Enhanced-MIMO BF setup (S13-1), Beam Training (S13-2), and Enhanced-MIMO BF Feedback (S13-3) are performed.

Note that, in FIG. 6, each sequence is an example, and other sequences may be adopted. For example, FIG. 6 illustrates a case where communication is performed from the access point AP in Capabilities Exchange (S11), but the communication may be performed first from the communication terminal STA, and the order of communication is not limited.

Furthermore, similarly, FIG. 6 illustrates that communication is performed first from the access point AP in Enhanced-MIMO BF setup (S13-1) and Beam Training (S13-2), but the communication may be performed first from the communication terminal STA. As the order for performing of communication in Beam Training (S13-2), communication may be performed from the terminal that has performed Enhanced-MIMO BF setup (S13-1) first.

For example, in a case where Enhanced-MIMO BF setup is performed from the access point AP to the communication terminal STA after Enhanced-MIMO BF setup is performed from the communication terminal STA to the access point AP, Beam Training can also follow this, and Beam Training can be performed from the access point AP to the communication terminal STA after Beam Training is performed from the communication terminal STA to the access point AP. This transmission order policy may be understood in advance between the access point AP and the communication terminal STA.

Furthermore, FIG. 6 illustrates that Enhanced-MIMO BF Feedback (S13-3) is first performed from the communication terminal STA, but may be performed from the access point AP to the communication terminal STA first.

For example, in a case where Beam Training is performed from the access point AP to the communication terminal STA after Beam Training is performed from the communication terminal STA to the access point AP, Enhanced-MIMO BF Feedback may be performed from the access point AP to the communication terminal STA after Enhanced-MIMO BF Feedback is performed from the communication terminal STA to the access point AP. This transmission order policy may be understood in advance between the access point AP and the communication terminal STA.

Through Capabilities Exchange (S11), SISO Beamforming (S12), and MIMO Beamforming (S13), the access point AP and the communication terminal STA determine a combination of a DMG antenna set, an AWV, and precoding to perform Single User-MIMO (SU-MIMO).

(S11: Capabilities Exchange)

First, the access point AP and the communication terminal STA mutually perform information notification (Capabilities Exchange) regarding a capability of their own terminals (S11).

Capability Exchange may be performed by being included in, for example, a beacon signal periodically transmitted by each access point AP or information notification (association) for the communication terminal STA to be connected to the access point AP.

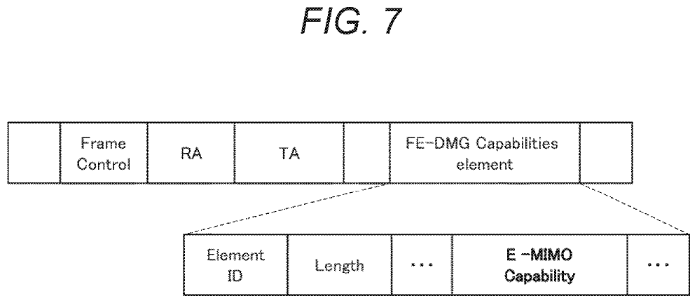

FIG. 7 illustrates a configuration example of a frame notification of which is provided in Capabilities Exchange.

This frame includes Frame Control, RA, TA, and FE-DMG Capabilities element. However, the components of the frame are not limited thereto.

The Frame Control includes information indicating that the frame is a frame notification of which is provided in Capabilities Exchange.

The receiver address (RA) and the transmitter address (TA) respectively include information indicating a destination terminal and information indicating a transmission source communication device. For example, a terminal-specific MAC address may be indicated in the RA and the TA.

The Further-enhanced directional multi gigabit (FE-DMG) Capabilities element includes information indicating propriety of performing subsequent SISO Beamforming (S12) and MIMO Beamforming (S13). The FE-DMG Capabilities element includes fields that are Element ID, Length, and E-MIMO Capability.

The Element ID includes information indicating that the element is the FE-DMG Capabilities element. The Length includes information indicating a bit length of the FE-DMG Capabilities element.

The enhanced-MIMO (E-MIMO) Capability includes information indicating propriety of performing subsequent SISO Beamforming and MIMO Beamforming in a terminal that provides notification of the frame, and information regarding reciprocity of the antenna.

In a case where a terminal (the access point AP or the communication terminal STA) notified of the frame is notified that SISO Beamforming and MIMO Beamforming can be performed in E-MIMO Capabilities and has provided notification that the self can also similarly perform those in the frame, SISO Beamforming and MIMO Beamforming can be performed with the terminal (the communication terminal STA or the access point AP) that has provided notification of the frame as a destination.

(S12: SISO Beamforming)

The access point AP and the communication terminal STA that have notified each other in Capabilities Exchange (S11) that SISO Beamforming and MIMO Beamforming can be performed perform link establishment (SISO Beamforming) for performing MIMO Beamforming (S12).

In SISO Beamforming, both the access point AP and the communication terminal STA determine a DMG antenna to be used in performing Enhanced-MIMO BF setup (S13-1) of subsequent MIMO Beamforming (S13) and an AWV to be used in the DMG antenna.

The access point AP transmits a known signal with several patterns of combinations of the DMG antenna and the AWV, and the communication terminal STA estimates an optimum combination of the DMG antenna and the AWV while receiving these known signals, and notifies the access point AP of an estimation result. The optimum herein may be, for example, a set having highest reception signal power.

Furthermore, similarly, the communication terminal STA transmits a known signal with several patterns of combinations of the DMG antenna and the AWV, and the access point AP estimates an optimum combination of the DMG antenna and the AWV while receiving these known signals, and notifies the communication terminal STA of an estimation result. The optimum herein may be, for example, a set having highest reception signal power.

Note that, in a case where transmission and reception of known signals have been performed between the access point AP and the communication terminal STA before SISO Beamforming, notification of only estimation results held by the access point AP and the communication terminal STA may be provided to each other.

(S13: MIMO Beamforming)

The access point AP and the communication terminal STA that have performed SISO Beamforming (S12) perform information notification and Beam Training (MIMO Beamforming) for determining the DMG antenna, the AWV, and precoding in MIMO transmission (S13).

In FIG. 6, MIMO Beamforming (S13) includes three phases of Enhanced-MIMO BF setup (S13-1), Beam Training (S13-2), and Enhanced-MIMO BF Feedback (S13-3).

In Beam Training, a known sequence pattern is transmitted with a combination of a DMG antenna set, an AWV, and any delay time (hereinafter, referred to as a delay time vector) to a DMG antenna to be used for transmission, and a communication device on the reception side receives the known sequence pattern while changing the combination of the DMG antenna set, the AWV, and the delay time vector on the reception side. As a result, the communication device on the reception side can estimate a combination, with good link quality, of the DMG antenna set, the AWV, and the delay time vector on the transmission side, and the DMG antenna set and the AWV delay time vector on the reception side.

At this time, by making the known sequence pattern to be orthogonal between the transmission antennas, the communication device on the reception side can estimate a propagation path for every transmission antenna.

### Case where Reciprocity of Antenna is Used

Furthermore, in FIG. 6, Enhanced-MIMO BF setup is performed first from the access point AP, but may be performed first from the communication terminal STA. In the following description, a terminal that has performed Enhanced-MIMO BF setup first will be referred to as an “initiator”, and another terminal will be referred to as a “responder”.

Although Enhanced-MIMO BF setup is performed from both the initiator and the responder, Beam Training and Enhanced-MIMO BF Feedback may not be performed by the responder, and may be performed only by the initiator. This is because a combination of a DMG antenna, an AWV, and a delay time vector to be used in uplink can be determined as long as Beam Training for only downlink can be performed, since a combination of a DMG antenna, an AWV, and a delay time vector for achieving optimum link quality in downlink (a link when the initiator transmits and the responder receives) and uplink (a link when the initiator receives and the responder transmits) is the same in only BF Training from the initiator, in a case where characteristics of the DMG antenna and the AWV are the same in transmission and reception in the initiator and the responder.

Note that information indicating the presence or absence of reciprocity of antennas in the access point AP and the communication terminal STA may be included in the E-MIMO Capability notification of which is provided in Capabilities Exchange. Furthermore, in a case where reciprocity differs depending on whether or not the delay time vector is applied, definition may be made in each case.

Note that, in the following description, a correlation between transmission and reception in characteristics of the DMG antenna and the AWV is referred to as reciprocity. In particular, a case is called “reciprocal” in which the reciprocity is the same between transmission and reception, that is, the characteristics of the DMG antenna and the AWV are the same at a time of transmission and at a time of reception, while other case is called “non-reciprocal”. Note that reciprocal mentioned below indicates that there is contradiction even when a delay time vector is applied.

Furthermore, similarly, in the case of reciprocal, Enhanced-MIMO BF Feedback may be performed only from the responder. This is because the responder can determine the optimum combination of the DMG antenna and the AWV in the uplink by Beam Training of downlink.

(S13-1: Enhanced-MIMO BF Setup)

The access point AP and the communication terminal STA that have performed SISO Beamforming (S12) perform, in MIMO Beamforming (S13), request (Enhanced-MIMO BF setup) in a format of information necessary for performing Beam Training and information notification of which is provided in Enhanced-MIMO BF Feedback (S13-1).

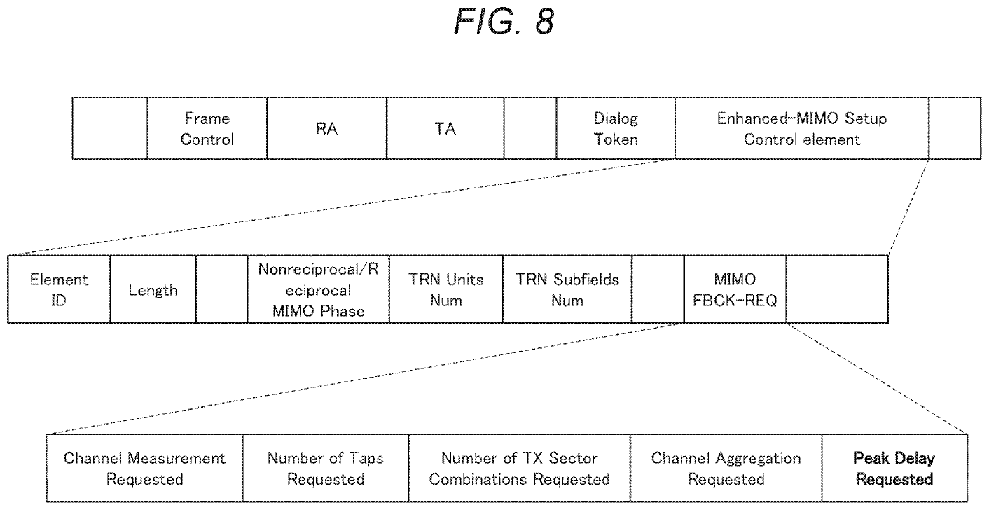

FIG. 8 illustrates a configuration example of a frame notification of which is provided in Enhanced-MIMO BF setup in MIMO Beamforming.

This frame includes Frame Control, RA, TA, Dialog Token, and Enhanced-MIMO Setup Control element. However, the components of the frame are not limited thereto.

The Frame Control includes information indicating that the frame is an Enhanced-MIMO BF setup frame.

The RA and the TA respectively include information indicating a destination terminal and information indicating a transmission source terminal. For example, a terminal-specific MAC address may be indicated in the RA and the TA.

The Dialog Token includes information for individually identifying the frame (Enhanced-MIMO BF Setup frame). The Enhanced-MIMO Setup Control element includes information about a known sequence in subsequent Beam Training (S13-2) and information regarding a request in a format of information notification of which is provided in Enhanced-MIMO BF Setup.

Note that the frame may be configured to indicate that the frame is Enhanced-MIMO BF setup by combining information in Frame Control and other fields.

The Enhanced-MIMO Setup Control element includes fields that are Element ID, Length, Nonreciprocal/Reciprocal MIMO Phase, TRN Units Num, TRN Subfields Num, and MIMO FBCK-REQ.

The Element ID includes information indicating that the element is the Enhanced-MIMO Setup Control element. The Length includes information indicating a bit length of the Enhanced-MIMO Setup Control element.

The Nonreciprocal/Reciprocal MIMO Phase includes information indicating a request for propriety of performing Beam Training from the responder in subsequent Beam Training. The TRN Units Num and the TRN Subfields Num include information indicating a request related to a known sequence pattern transmitted by a communication partner in subsequent Beam Training.

The MIMO FBCK-REQ includes information regarding a request in a format of information notification of which is provided in Enhanced-MIMO Feedback. The MIMO FBCK-REQ includes subfields that are Channel Measurement Requested, Number of Taps Requested, Number of TX Sector Combinations Requested, Channel Aggregation Requested, and Peak Delay Request.

The Channel Measurement Requested includes information indicating a notification request for complex propagation path information for a set of a DMG antenna set and an AWV of a communication device on the transmission side and a notification device on the reception side used in Beam Training in Enhanced-MIMO Feedback.

The Number of Taps Requested includes information indicating a request value of a time tap representing a complex propagation path, for complex propagation path information notification of which is provided in Enhanced-MIMO Feedback.

The Number of TX Sector Combinations Requested includes information indicating a request value of the number of combinations of a DMG antenna set, an AWV, and a delay vector to be used in Beam Training to be performed by a notification partner, by a terminal that has performed Enhanced-MIMO BF setup first in subsequent Beam Training.

The Peak Delay Request includes information indicating that a DMG antenna that transmits a known sequence in Beam Training is requested to notify a difference in time at which an impulse response of each transmission DMG antenna peaks, in Enhanced-MIMO BF Feedback (S13-3).

(S13-2: Beam Training)

The access point AP and the communication terminal STA that have performed Enhanced-MIMO BF setup (S13-1) perform transmission and reception (Beam Training) of a known sequence pattern while changing the DMG antenna set, the AWV, and the delay time vector (S13-2). Note that Beam Training may be replaced with Beamforming Training.

In Beam Training, an enhanced-beam refinement protocol (E-BRP) including a TRN as an example of a reference signal is transmitted a plurality of times. At this time, in different E-BRPs, a DMG antenna set, an AWV, and a delay time vector to be used for transmission may be different.

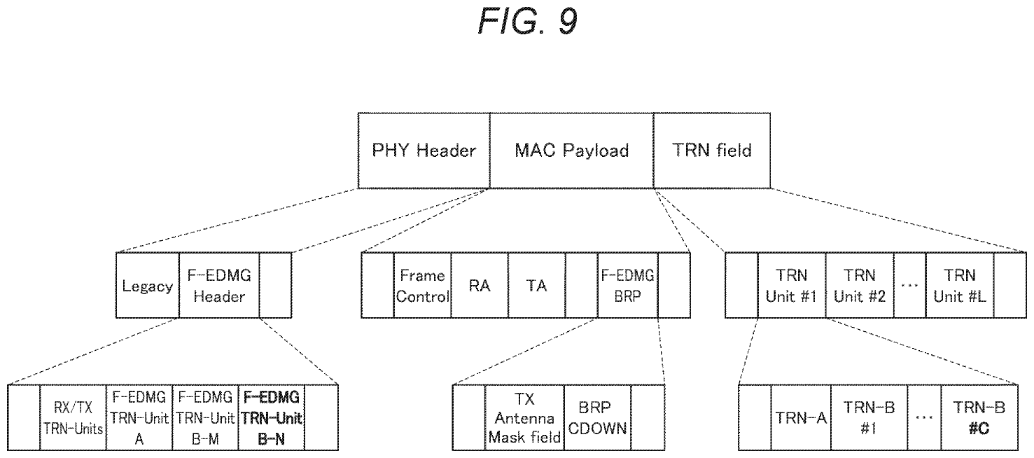

FIG. 9 illustrates a configuration example of a frame (hereinafter, also referred to as an E-BRP frame) notified in Beam Training.

This frame includes PHY Header, MAC Payload, and TRN field. However, the components of the frame are not limited thereto.

The PHY Header includes signals and information necessary for synchronization and demodulation required for reception of the frame, and information regarding the TRN field at the end.

The MAC Payload includes information regarding a DMG antenna set used to transmit the frame and the number of E-BRP frames scheduled to be transmitted subsequently. The TRN field includes a known sequence pattern.

The PHY Header includes fields that are Legacy and F-EDMG Header.

The Legacy includes a known sequence for performing time synchronization and frequency synchronization, and a known sequence for estimating a propagation path for demodulating subsequent F-EDMG Header.

The F-EDMG Header includes information regarding components of the TRN field. In particular, the F-EDMG Header includes elements that are RX/TX TRN-Units, F-RDMG TRN Unit A, F-EDMG TRN Unit B-M, and F-EDMG TRN Unit B-N.

The RX/TX TRN-Units include information indicating the number of TRN Units in the TRN field. The F-RDMG TRN Unit A includes information regarding a length of TRN-A included in each of TRN Units in the TRN field.

The F-EDMG TRN Unit B-M and the F-EDMG TRN Unit B-N include information regarding a length of TRN-B included in each TRN Unit in the TRN field. In particular, in the F-EDMG TRN Unit B-N, the number of patterns of a delay time vector is indicated in the TRN of the TRN field, and a pattern of the delay time vector may be indicated as 1 in a case where the delay time vector is not applied.

Note that the delay time vector here does not have to be a fixed value, for avoiding unintended beam formation such as cyclic shift delay (CSD) in Document 4 below. For example, a delay time of (i×Tₛ)/4 or (i×Tₛ)/8 may be applied to the i-th DMG antenna for a sampling period Tₛ.
Document 4: IEEE 802.11, 2016

The MAC Payload includes fields that are Frame Control, RA, TA, and F-EDMG BRP.

The Frame Control includes information indicating that this frame is the E-BRP frame. The RA and the TA respectively include information indicating a destination terminal and a transmission source terminal.

The F-EDMG BRP includes information regarding the E-BRP frame other than that described above. In particular, the F-EDMG BRP includes subfields that are Tx Antenna Mask filed and BRP CDOWN.

The Tx Antenna Mask filed includes information indicating a DMG antenna used to transmit the E-BRP frame. The BRP CDOWN includes information indicating the number of remaining frames of the E-BRP transmitted in Beam Training.

As a specific example, the following information may be stored in the Tx Antenna Mask field. Here, when the Tx Antenna Mask field has an 8-bit length and the number of DMG antennas that can be mounted on the terminal is 8 at maximum, each bit may represent use (“1”) or non-use (“0”) of an antenna that can be mounted. For example, in a case where there are four DMG antennas that can be used for transmission, when the E-BRP is transmitted using the first, third, and fourth antennas among the four DMG antennas, information of “00001101” may be stored in the Tx Antenna Mask field.

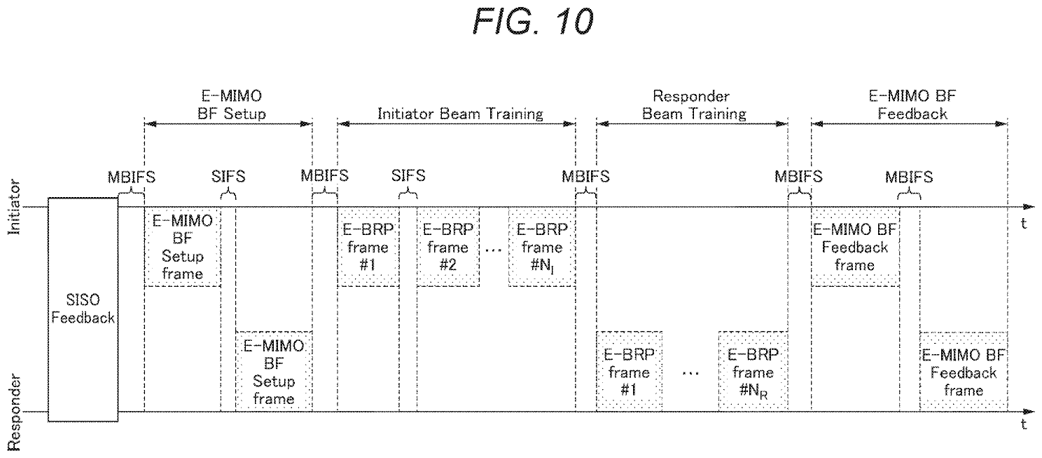

Furthermore, as a specific example of the BRP CDOWN, the following information may be stored. Here, it is assumed that N_{I} pieces of E-BRP frame are transmitted from the initiator and N_{R} pieces of E-BRP frame are transmitted from the responder in Beam Training. In Beam Training in this case, the E-BRP is transmitted as illustrated in FIG. 10.

In FIG. 10, “E-MIMO” is an abbreviation for Enhanced-MIMO, and for example, “E-MIMO BF Setup” indicates a period of Enhanced-MIMO BF setup (S13-1). Furthermore, in FIG. 10, a period during which the E-BRP frame is transmitted from the initiator is indicated by “Initiator Beam Training”, and a period during which the E-BRP frame is transmitted from the responder is indicated by “Responder Beam Training”.

During the period of Initiator Beam Training, information indicating (N_{I}−₁) may be stored in CDOWN included in the E-BRP frame (that is, E-BRP frame #k₁) transmitted at the k₁-th time (1≤k₁≤N_{I}). Similarly, during the period of Responder Beam Training, information indicating (N_{R}−k₂) may be stored in CDOWN included in the E-BRP frame (that is, E-BRP frame #k₂) transmitted at the k₂-th time (1≤k₂≤N_{R}).

As a result, when CDOWN in the E-BRP frame notification of which is provided is “0”, a terminal notified of the E-BRP frame during Initiator Beam Training or Responder Beam Training may interpret that the frame is the last E-BRP frame notification of which is provided in Initiator Beam Training or Responder Beam Training.

At this time, as a transmission interval (an inter frame space (IFS)) of each frame described in FIG. 10, medium BF IFS (MBIFS) and SIFS (short IFS) of Document 4 described above may be used.

Specifically, IFS between E-BRP frames in each of the periods of Initiator Beam Training and Responder Beam Training may be set to a value defined as SIFS, and a value defined as MBIFS may be used as IFS between Initiator Beam Training and Responder Beam Training. At this time, since the responder switches from a reception operation to a transmission operation when switching from Initiator Beam Training to Responder Beam Training, the MBIFS may be defined as a value longer than the SIFS.

Note that, in a case where it is requested from the initiator and the responder not to perform Responder Beam Training on the basis of information of the Nonreciprocal/Reciprocal MIMO Phase field in the frame notification of which is provided in Enhanced-MIMO BF Setup, frame transmission from the initiator in Responder Beam Training or Enhanced MIMO BF Feedback may be omitted.

Returning to the description of FIG. 9, the TRN field includes TRN Unit. Each TRN Unit includes fields that are TRN-A and TRN-B.

The TRN-A includes a known sequence transmitted with a defined DMG antenna set and a defined AWV. The TRN-B includes a known sequence transmitted with a DMG antenna set, an AWV, and a delay time vector for which quality is desired to be estimated on the transmission side in Beam Training.

Note that, as the DMG antenna set and the AWV to be used in the TRN-A, the same combination as the DMG antenna set and the AWV used in transmission of the PHY Header may be used.

A different TRN Unit may be transmitted with a different DMG antenna set, a different AWV, and a different delay time vector.

Furthermore, in a case where there is a plurality of pieces of TRN-B included in one TRN Unit, some pieces of TRN-B may be the same. This is because, while a propagation path of a combination of a DMG antenna set, an AWV, and a different delay time vector in a destination terminal is estimated with the TRN-B, for the DMG antenna set and the AWV being used for transmission, it is necessary to be able to estimate a propagation path in a time division manner for every set, for example, in a case where there is a plurality of combinations of a DMG antenna set, an AWV, and a delay time vector held by the destination terminal. At this time, the destination terminal may perform reception by switching the set of the DMG antenna set, the AWV, and the delay time vector for each piece of TRN-B.

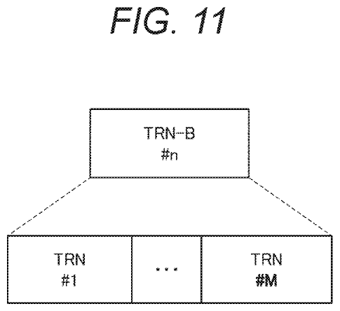

Furthermore, the TRN-B may be configured as illustrated in FIG. 11 such that transmission can be performed by using some patterns, when transmission is performed with a delay time vector applied to the transmission DMG antenna.

In FIG. 11, fields including known sequences of TRN #1 to TRN #M are present in the TRN-B. As TRN #1 to TRN #M, known sequences as shown in the following Equation (2) may be applied.

[Formula 2]

TRN_{(q)}^{(m)}=PS_{(q)}^{(m)} (2)

However, in Equation (2), TRN ((m);(q)) on the left side indicates a sequence transmitted at the q-th sample in TRN #m, P on the right side indicates a precoding matrix in a time domain on the transmission side, and S((m);(q)) on the right side indicates a sequence before precoding is applied on a sequence transmitted at the q-th sample in TRN #m. Note that q indicates a sample number when a head sample of the TRN is set to 0 in each TRN, and TRN((m);(q)) is not defined outside the period of the TRN.

Note that, here, for convenience of description, when A(b;c) is described, b represents a superscript for A, and c represents a subscript for A. For example, when TRN((m);(q)) is described, (m) means a superscript and (q) means a subscript for TRN. Furthermore, when S((m);(q)) is described, (m) means a superscript and (q) means a subscript for S. These relationships are similarly applied to the description described later.

At this time, S((m);(q)) may be a sequence represented by the following Equation (3) or Equation (4).

$$\begin{matrix}[ Formula 3 ] & \\ {S}_{( q )}^{( m )} = [ \begin{matrix}{s}_{1}^{m} ( q ) \\ ⋮ \\ {S}_{{N}_{t}}^{m} ( q )\end{matrix} ] , \\ s . t . … {s}_{n}^{m} ( q ) = \frac{1}{K} {\sum }_{l = idx ( {f}_{min} )}^{idx ( {f}_{max} )} [ {\sum }_{k = idx ( {f}_{min} )}^{idx ( {f}_{max} )} {s}_{n} ( q ) {e}^{\frac{- j 2 π k}{{T}_{s}} ( q - {τ}_{n}^{m} )} ] {e}^{\frac{j 2 π l}{{T}_{s}} q} & ( 3 )\end{matrix}$$

$$\begin{matrix}[ Formula 4 ] & \\ {S}_{( q )}^{( m )} = [ \begin{matrix}{s}_{1}^{m} ( q - {τ}_{1}^{m} ) \\ ⋮ \\ {S}_{{N}_{t}}^{m} ( q - {τ}_{{N}_{t}}^{m} )\end{matrix} ] & ( 4 )\end{matrix}$$

In Equations (3) and (4), s(m;n) (q) is a sequence transmitted by the n-th DMG antenna, and is a sequence transmitted at the q-th sample in TRN #m and is a sequence before precoding is applied.

Furthermore, K represents a normalization coefficient, T_{S} represents a sampling period, i(m;n) represents any minute delay time (that is, an element of a delay time vector) applied to a sequence transmitted by the n-th DMG antenna in TRN #m, and fₘₐₓ and fₘᵢₙ represent a maximum frequency and a minimum frequency in a baseband signal of a signal to be transmitted. In a case where the transmission signal uses the OFDM modulation scheme, fₘₐₓ and fₘᵢₙ may be a maximum subcarrier wave frequency and a minimum subcarrier wave frequency for the baseband signal to be transmitted.

Furthermore, sₙ(q) represents a sequence orthogonal for different n in a period of TRN #m. For example, sₙ(q) may be represented by a Golay sequence. Furthermore, the function idx(f) is a mapping function that represents a phase shift amount in a T_{S} period as 2π f/T_{S}[rad.] for a frequency f in the baseband signal. T_{S} is a block length excluding a guard interval in a case of a single-carrier transmission scheme, and may be a 1 OFDM symbol length excluding a guard interval in a case of the OFDM modulation scheme.

Equation (3) described above represents a sequence generation example in a case where time-frequency conversion is possible by discrete Fourier transformation (DFT) or the like in the signal processing unit 113 or the additional delay compensation unit 115 in the communication device 10 on the transmission side. Whereas, Equation (4) represents a generation example in a case where the signal processing unit 113, the additional delay compensation unit 115, and the wireless interface unit 116 can perform delay in the time domain.

In this case, information indicating the number of pieces of TRN-B may be included in the F-EDMG TRN Unit B-N, and information indicating the number of pieces of TRN included in each TRN-B may be included in the F-EDMG TRN Unit B-M.

(S13-3: Enhanced-MIMO BF Feedback)

The access point AP and the communication terminal STA that have performed Beam Training (S13-2) perform notification (Enhanced-MIMO BF Feedback) of an estimation result regarding the DMG antenna set, the AWV, and the delay time vector obtained by Beam Training (S13-3).

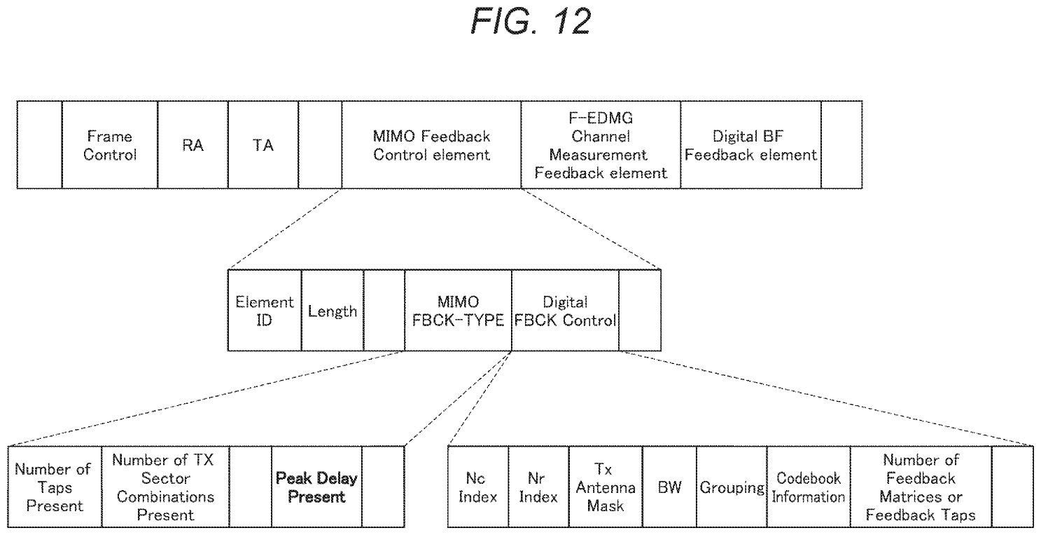

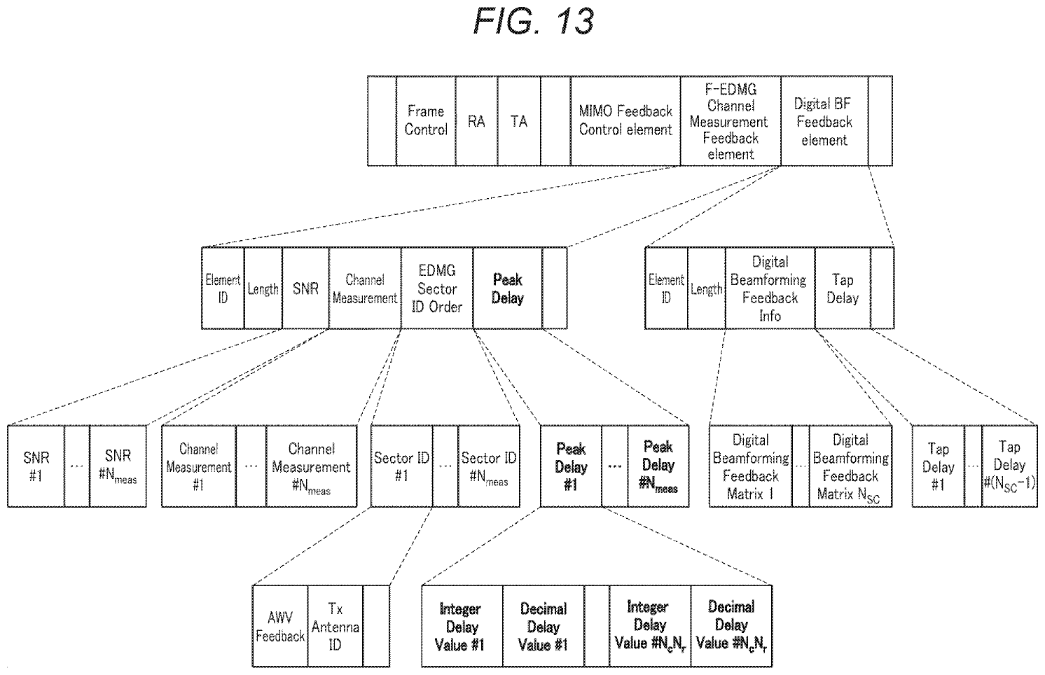

FIGS. 12 and 13 illustrate a configuration example of a frame notification of which is provided in Enhanced-MIMO BF Feedback.

This frame includes Frame Control, RA, TA, MIMO Feedback Control element, F-EDMG Channel Measurement Feedback element, and Digital BF Feedback element. However, the components of the frame are not limited thereto.

The Frame Control includes information indicating that the frame is a frame notification of which is provided in Enhanced-MIMO BF Feedback. The RA and the TA respectively include information indicating a destination terminal and a transmission source terminal.

The MIMO Feedback Control element includes information regarding a format of the subsequent F-EDMG Channel Measurement Feedback element and Digital BF Feedback element.

The F-EDMG Channel Measurement Feedback element includes information regarding a signal-to-noise ratio (SNR) and an arrival time of a propagation path, for the combination of the DMG antenna set, the AWV, the delay time vector estimated by Beam Training.

The Digital BF Feedback element includes information regarding a propagation path obtained in a case where the E-BRP frame is transmitted using a plurality of DMG antennas simultaneously in Beam Training.

FIG. 12 illustrates a detailed configuration of the MIMO Feedback Control element, and FIG. 13 illustrates a detailed configuration of the F-EDMG Channel Measurement Feedback element and the Digital BF Feedback element.

As illustrated in FIG. 12, the MIMO Feedback Control element includes fields that are Element ID, Length, MIMO FBCK-TYPE, and Digital FBCK Control.

The Element ID includes information indicating that the element is the MIMO Feedback Control element. The Length includes information indicating a bit length of the MIMO Feedback Control element.

The MIMO FBCK-TYPE and the Digital FBCK Control include information regarding formats of the F-EDMG Channel Measurement Feedback element and the Digital BF Feedback element.

In FIG. 12, the MIMO FBCK TYPE includes subfields that are Number of Taps Present, Number of TX Sector Combinations Present, and Peak Delay Present.

The Number of Taps Present includes information regarding the number of time taps of propagation path information notification of which is provided in this frame and the presence or absence of the number of time taps.

The Number of TX Sector Combinations Present includes information regarding the number of combinations of a DMG antenna set and an AWV notification of which is provided in the frame.

The Peak Delay Present includes information indicating the presence or absence of the Peak Delay in the F-EDMG Channel Measurement element.

In FIG. 12, the Digital FBCK Control includes subfields that are Nc Index, Nr Index, Tx Antenna Mask, BW, Grouping, Codebook Information, Number of Feedback Matrices or Feedback Taps.

The Nc Index and the Nr Index include information regarding a format of propagation path information indicated in Digital Beamforming Feedback Info in the Digital BF Feedback element.

The Tx Antenna Mask includes information indicating a DMG antenna set in propagation path information indicated in the Digital Beamforming Feedback Info in the Digital BF Feedback element.

The BW includes information indicating a frequency band of propagation path information indicated in the Digital Beamforming Feedback Info in the Digital BF Feedback element.

The Grouping includes information indicating one or more frequencies of propagation path information indicated in the Digital Beamforming Feedback Info in the Digital BF Feedback element in the frequency band indicated by BW.

The Codebook Information includes information indicating a resolution represented by one bit, for propagation path information indicated in the Digital Beamforming Feedback Info in the Digital BF Feedback element.

The Number of Feedback Matrices or Feedback Taps includes: information indicating whether Digital Beamforming Feedback Matrix included in the Digital Beamforming Feedback Info in the Digital BF Feedback element represents a time domain or a frequency domain; and information indicating the number of Digital Beamforming Feedback Matrix subfields.

As illustrated in FIG. 13, the F-EDMG Channel Measurement Feedback element includes subfields that are Element ID, Length, SNR, Channel Measurement, EDMG Sector ID Order, and Peak Delay.

The Element ID includes information indicating that the element is the F-EDMG Channel Measurement Feedback element. The Length includes information indicating a bit length of the F-EDMG Channel Measurement Feedback element.

The SNR includes subfields of SNR #1 to #N_{Meas}, and each subfield individually includes information indicating the SNR observed in Beam Training, for a combination of a DMG antenna set, an AWV, and a delay time vector indicated in Sector IDs #1 to #N_{Meas} in the EDMG Sector ID Order.

The Channel Measurement includes subfields of Channel Measurement #1 to #N_{Meas}, and each subfield individually includes information indicating the SNR observed in Beam Training, for a combination of a DMG antenna set, an AWV, and a delay time vector indicated in Sector IDs #1 to #N_{Meas} in the EDMG Sector ID Order.

The EDMG Sector ID Order includes subfields of Sector IDs #1 to #N_{Meas}, and each includes information regarding a combination of a DMG antenna set, an AWV, and a delay time vector used for transmission of any E-BRP frame among a plurality of E-BRP frames observed in Beam Training.

The Peak Delay includes subfields of Peak Delay #1 to #N_{Meas}, and each subfield individually includes information regarding an arrival time of a propagation path observed in a Beam Training period, for a combination of a DMG antenna set, an AWV, and a delay time vector indicated in Sector IDs #1 to #N_{Meas} in the EDMG Sector ID Order.

As illustrated in FIG. 13, the Digital BF Feedback element includes subfields that are Element ID, Length, Digital Beamforming Feedback Info, and Tap Delay.

The Element ID includes information indicating that the element is the Digital BF Feedback element. The Length includes information indicating a bit length of the Digital BF Feedback element.

The Digital Beamforming Feedback Info includes information indicating a complex matrix representing propagation path information. The Tap Delay includes information indicating the number of time taps of propagation path information indicated in the Digital Beamforming Feedback Info.

### Specific Example

As a specific example, information may be included as follows.

Here, it is assumed that a plurality of E-BRP frames from the initiator is transmitted in Beam Training, and it is assumed that the E-BRP frame is transmitted with all N_{All} combinations of a DMG antenna set, an AWV, and a delay vector used by the initiator for transmission, and a DMG antenna set, an AWV, and a delay time vector used by the responder for reception, for the transmitted E-BRP frame in Enhanced-MIMO Feedback.

It is assumed that, in E-MIMO BF Feedback, the responder provides notification of a result of Beam Training for N_{TSC} combinations among the N_{All} combinations.

At this time, for the N_{TSC} combinations of the DMG antenna set, the AWV, and the delay vector as a notification target, when the number of transmission antennas used by the initiator is set to N((i);T), and the number of transmission antennas used by the responder is N((i);R) in the i-th combination of the DMG antenna set, the AWV, and the delay vector, N_{Meas} has a relationship represented by the following Equation (5).

$$\begin{matrix}[ Formula 5 ] & \\ {N}_{Meas} = {\sum }_{i = 1}^{{N}_{TSC}} {N}_{T}^{( i )} {N}_{R}^{( i )} & ( 5 )\end{matrix}$$

For example, in Beam Training, in a case where the initiator transmits each E-BRP frame with two DMG antenna sets, the responder receives each E-BRP frame with one DMG antenna set, and the E-BRP frame is transmitted four times, N_{All} is 8, and N_{Meas} is 8 at maximum.

The information indicating N_{Meas} described above is included in the Number of TX Sector Combinations Present of the MIMO FBCK-TYPE in the MIMO Feedback Control element.

At this time, among of N_{Meas} combinations (that is, the N_{TSC} combinations of the DMG antenna set and the AWV) of the DMG antenna and the AWV as a notification target, information indicating a transmission DMG antenna of the initiator in the i-th combination is indicated in Tx Antenna ID of Sector ID #i in the EDMG Sector ID Order, and information indicating a transmission AWV of the initiator in the i-th combination is indicated in AWV Feedback of Sector ID #i in the EDMG Sector ID Order.

The E-BRP frame transmitted with the i-th combination as a notification target can be identified by a value indicated by CDOWN in the F-EDMG BRP field in the MAC Payload. Furthermore, as described above, since the known sequence orthogonal for every transmission antenna is transmitted in the TRN field in the E-BRP frame, it is possible to estimate propagation path information of different transmission DMG antennas and reception DMG antennas in the E-BRP frame.

Therefore, since the AWV Feedback includes information indicating the value of the CDOWN in the E-BRP frame transmitted with the DMG antenna set, the AWV, and the delay time vector of the combination as a notification target, and the Tx Antenna ID includes information indicating any one DMG antenna in the DMG antenna set, a terminal notified of the frame can specify the DMG antenna set, the AWV, and the delay time vector as a notification target from the CDOWN in Beam Training, and further specify one transmission DMG antenna as a notification target from the Tx Antenna ID.

Note that, although not illustrated in the figure, information indicating a reception antenna or an AWV of the responder in the i-th combination may be included in Sector ID #i in the EDMG Sector ID Order.

Furthermore, the SNR observed by the responder in Beam Training for the N_{TSC} combinations of the DMG antenna set, the AWV, and the delay time vector as a notification target is indicated in the SNR field in the F-EDMG Channel Measurement Feedback element. At this time, information indicating the SNR of the i-th combination among the N_{Meas} combinations of the DMG antenna and the AWV may be included in SNR #i of the SNR field in the F-EDMG Channel Measurement Feedback element.

Furthermore, similarly, for the N_{Meas} combinations of the DMG antenna set, the AWV, and the delay time vector as a notification target, information indicating a peak time with respect to a time response of a propagation path observed by the responder in Beam Training is indicated in the Peak Delay in the F-EDMG Channel Measurement Feedback element. At this time, for the i-th combination among the N_{Meas} combinations of the DMG antenna set and the AWV, information indicating the peak time may be included in Peak Delay #i of the Peak Delay field in the F-EDMG Channel Measurement Feedback element.

Moreover, in a case where the responder can estimate the peak time with a resolution equal to or more than a sample time by using oversampling or interpolation operation, Integer Delay Value in Peak Delay #i includes a delay time amount in units of a prescribed sample, and Decimal Delay Value includes information indicating a delay time amount that is equal to or less than the prescribed sample. Note that, in a case where the Peak Delay is present, information indicating the presence of the Peak Delay is included in Peak Delay Present in the MIMO FBCK-TYPE in the MIMO Feedback Control element.

The Peak Delay may be made present in a frame notification of which is provided in Enhanced-MIMO BF Feedback for Beam Training among frames notification of which is provided in Beam Training, in a case where it is indicated that a delay time vector is not applied between the transmission DMG antennas in the F-EDMG TRN-Unit B-N in the F-EDMG Header in the PHY Header (that is, in a case where it is indicated that the pattern of the delay time vector is 1).

### Specific Example: N_{TSC}≥2: Case where No Digital BF Feedback Element is Present

In a case where there is a plurality of combinations of the DMG antenna set, the AWV, and the delay time vector as a notification target, notification of propagation path information may be provided as follows. This specific example is an example in which no Digital BF Feedback element is present, and notification of the propagation path information is provided using the F-EDMG Channel Measurement Feedback element.

For N_{Meas} combinations of the DMG antenna set, the AWV, and the delay time vector as a notification target, a time response of a propagation path observed by the responder in Beam Training is indicated in the Channel Measurement field in the F-EDMG Channel Measurement Feedback element.

At this time, for the i-th combination among the N_{Meas} combinations of the DMG antenna set, the AWV, and the delay time vector, information indicating a time response of a propagation path, which is the number of time taps of Nₜₐₚₛ, may be included in Channel Measurement #i of the Channel Measurement field in the F-EDMG Channel Measurement Feedback element.

At this time, information indicating Nₜₐₚₛ is included in Number of Taps Present of MIMO FBCK-TYPE in the MIMO Feedback Control element. Note that the information indicating the time response of the propagation path is represented as information indicating a complex number, and both a real part and an imaginary part may be represented by 16 bits.

### Specific Example: N_{TSC}=1: Case where No Digital BF Feedback Element is Present

Furthermore, in a case where there is one combination of the DMG antenna set and the AWV delay time vector as a notification target (that is, when N_{TSC}=1 and a delay time vector is not applied in the transmission DMG antenna), notification of the propagation path information may be provided as follows. This example is an example in which the Digital BF Feedback element is present.

The transmission DMG antenna set as a notification target may be indicated in the Tx Antenna Mask in the Digital FBCK Control in the MIMO Feedback Control element.

At this time, the Digital Beamforming Feedback Info in the Digital BF Feedback element includes information indicating a propagation path matrix in a case where the transmission DMG antenna set and the AWV of the initiator as a notification target and the reception DMG antenna set and the AWV of the responder are used.

In a case where propagation path information notification of which is provided in the Digital Beamforming Feedback Info in the Digital BF Feedback element is indicated in a time domain, Number of Feedback Matrices or Feedback Taps in the Digital FBCK Control in the MIMO Feedback Control element stores information indicating being in the time domain and information indicating the number of time taps Nₜₐₚₛ of the propagation path information, for the propagation path information notified in the Digital Beamforming Feedback Info in the Digital BF Feedback element.

The notification in such a format may be performed in a case where the responder cannot estimate channel quality in the frequency domain, such as a case where the responder cannot perform DFT, or in a case where the initiator cannot perform transmission with the OFDM modulation scheme. Note that information regarding each time tap is indicated in the Tap Delay in the Digital BF Feedback element. Furthermore, the information indicating the time response of the propagation path is represented as information indicating a complex number, and both a real part and an imaginary part may be represented by 16 bits.

Furthermore, in a case where propagation path information notification of which is provided in the Digital Beamforming Feedback Info in the Digital BF Feedback element is indicated in a frequency domain, the Number of Feedback Matrices or Feedback Taps in the Digital FBCK Control in the MIMO Feedback Control element stores information indicating being in the frequency domain and information indicating the number of frequencies of propagation path information notification of which is to be provided, for the propagation path information notification of which is provided in the Digital Beamforming Feedback Info in the Digital BF Feedback element.

Note that, while information indicating the frequency of the propagation path information notification of which is provided in BW and Grouping in the Digital FBCK Control in the MIMO Feedback Control element is indicated, in a case where a degree of freedom represented by these is limited, information indicated in the Number of Feedback Matrices or Feedback Tap in the Digital FBCK Control in the MIMO Feedback Control element may be prioritized. Furthermore, information indicating the time response of the propagation path may be according to the Compressed BF Feedback described in Document 4.

(In Case of Reciprocal)

FIG. 6 illustrates a case where notification of information is provided from each of the access point AP and the communication terminal STA in Enhanced-MIMO BF Feedback (S13-3). However, in a case where there is reciprocity (reciprocal) of transmission/reception antennas in both terminals, the notification may be from one communication device.

For example, in Enhanced-MIMO BF Setup, in a case where the initiator and the responder notify each other of a request not to perform Beam Training from the responder in Nonreciprocal/Reciprocal MIMO Phase in the Enhanced-MIMO Setup Control element, and Beam Training from responder is not performed, only the responder notifies the initiator of this frame in Enhanced-MIMO BF Feedback.

At this time, it is assumed that, in Beam Training performed by the initiator, an E-BRP frame is transmitted indicating that there is a plurality of numbers of patterns of the time delay applied between transmission antennas in a TRN of the TRN field in the F-EDMG TRN Unit B-N in the F-EDMG Header in the PHY Header, and notification of information indicating a combination of a DMG antenna set, an AWV, and a delay time vector is provided in Enhanced-MIMO BF Feedback.

That is, this is a case where a value of BRP CDOWN in the F-EDMG BRP in the E-BRP frame transmitted by the initiator with any delay time vector applied in Beam Training is indicated by AWV Feedback in any Sector ID in the EDMG Sector ID Order in the F-EDMG Channel Measurement Feedback element in the frame notification of which is provided by the responder in Enhanced-MIMO BF Feedback.

In this case, in a case where the initiator determines that the DMG antenna set, the AWV, and the delay time vector indicated by the BRP CDOWN satisfy optimum communication quality on the basis of the frame notification of which is provided from the responder, and uses the setting in data transmission, the same setting may be used not only at the time of transmission but also at the time of reception. That is, the delay time vector indicated by the BRP CDOWN is applied, and reception is performed.

Similarly, while the responder that has received the E-BRP frame through Beam Training from the initiator determines an optimum combination from combinations of its own DMG antenna set, AWV, and delay time vector, setting with the same combination may also be used in transmission.

In the first embodiment, in particular, even when Nₜₐₚ=1, since information for compensating for spatial wideband effect can be obtained on the basis of information indicated in the Peak Delay field in the F-EDMG Channel Measurement Feedback element, reduction in an amount of feedback information can be expected.

In the communication device 10 that performs such processing as described above, the following processing is performed by at least one control unit out of the control unit 100 and the wireless control unit 110.

That is, in a first communication device 10 (for example, the communication terminal STA) including one or more antennas, on the basis of a reference signal (for example, the E-BRP frame in FIG. 9) transmitted from a second communication device 10 (for example, the access point AP) including one or more antennas, first information (for example, the frame in FIGS. 12 and 13) including: information (for example, the Peak Delay in FIG. 13) regarding an arrival time of a reference signal (for example, with a resolution equal to or more than a sample time); and information indicating that the information regarding the arrival time is included (for example, the Peak Delay Present in FIG. 12) is generated for each combination of antennas included in the first communication device 10 and the second communication device 10, and the generated first information is transmitted to the second communication device 10.

In this first communication device 10 (for example, the communication terminal STA), second information (for example, the FE-DMG Capabilities element in FIG. 7) is generated indicating that the first information can be generated and transmitted to another communication device 10, and the generated second information is transmitted to the second communication device 10.

In this first communication device 10 (for example, the communication terminal STA), on the basis of third information (for example, the Peak Delay Request in FIG. 8) notification of which is provided from the second communication device 10 and requesting that the first communication device 10 provides notification of the first information after the second communication device 10 transmits a reference signal, the first information is generated after the second communication device 10 transmits the reference signal, and the generated first information is transmitted to the second communication device 10.

Furthermore, in a third communication device 10 (for example, the access point AP) including one or more antennas, with respect to a reference signal element (for example, the TRN-B in FIG. 9) generated on the basis of a delay time vector, a reference signal (for example, the E-BRP frame in FIG. 9) including one or more reference signal elements is transmitted to a fourth communication device 10 (for example, the communication terminal STA) including one or more antennas.

In this third communication device 10 (for example, the access point AP), for one or more reference signal elements included in the reference signal, sixth information (for example, the F-EDMG TRN Unit B-N in FIG. 9) is generated indicating the number of patterns of the delay time vector used to generate the reference signal element, and the generated sixth information is transmitted to the fourth communication device 10.

In this third communication device 10 (for example, the access point AP), after the fourth communication device 10 transmits the reference signal, seventh information is generated on the basis of eighth information (for example, the Peak Delay Request in FIG. 8) notification of which is provided from the fourth communication device 10 and requesting that the third communication device 10 provides notification of the seventh information (for example, the frame in FIGS. 12 and 13) that includes: information (for example, the Peak Delay in FIG. 13) regarding an arrival time of a reference signal (for example, with a resolution equal to or more than a sample time); and information (for example, the Peak Delay Present in FIG. 12) indicating that the information regarding the arrival time is included, for each combination of antennas included in the third communication device 10 and the fourth communication device 10 after the fourth communication device 10 transmits the reference signal, and the generated seventh information is transmitted to the fourth communication device 10.

In this third communication device 10 (for example, the access point AP), eleventh information (for example, the FE-DMG Capabilities element in FIG. 7) is generated indicating that it is possible to transmit the reference signal (for example, the E-BRP frame in FIG. 9) including one or more reference signal elements, with respect to a reference signal element (for example, the TRN-B in FIG. 9) generated on the basis of a delay time vector, and the generated eleventh information is transmitted to the fourth communication device 10.

By performing such processing between the plurality of communication devices 10 (for example, the access point AP and the communication terminal STA), effective throughput can be improved even in a case where the spatial-wideband effect remarkably occurs, so that deterioration of communication quality can be suppressed.

### 2. Second Embodiment

(Overall Sequence)

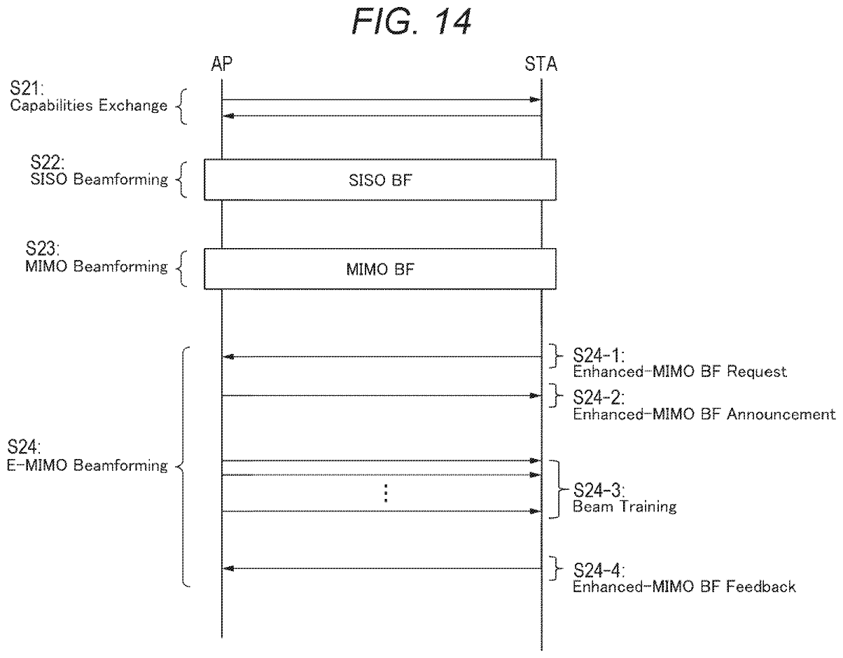

FIG. 14 illustrates a second example of the entire sequence of the present technology. Also in FIG. 14, similarly to the wireless network system of FIG. 1, it is assumed that there is one access point AP and one communication terminal STA.

In the sequence of FIG. 14, four steps of Capabilities Exchange (S21), SISO Beamforming (S22), MIMO Beamforming (S23), and E-MIMO Beamforming (S24) are performed between the access point AP and the communication terminal STA.

That is, in the sequence of FIG. 14, SISO Beamforming (S22) and MIMO Beamforming (S23) are similar to SISO Beamforming (S12) and MIMO Beamforming (S13), as compared with the sequence of FIG. 6.

Furthermore, in E-MIMO Beamforming (S24), four sub-steps of Enhanced-MIMO BF Request (S24-1), Enhanced-MIMO BF Announcement (S24-2), Beam Training (S24-3), and Enhanced-MIMO BF Feedback (S24-4) are performed. However, as described later, Enhanced-MIMO BF Request may be omitted in a case where notification of similar information is provided in MIMO Beamforming.

Through Capabilities Exchange, SISO Beamforming, MIMO Beamforming, and E-MIMO Beamforming, the access point AP and the communication terminal STA determine a combination of a DMG antenna set, an AWV, and a delay time vector to perform Single User-MIMO (SU-MIMO).

(S21: Capabilities Exchange)

First, the access point AP and the communication terminal STA mutually perform information notification (Capabilities Exchange) regarding a capability of their own terminals.

Capability Exchange may be performed by being included in, for example, a beacon signal periodically transmitted by each access point AP or information notification (association) for the communication terminal STA to be connected to the access point AP.

FIG. 14 illustrates a case where communication is performed from the access point AP in Capabilities Exchange, but the communication may be performed first from the communication terminal STA, and the order of communication is not limited. A frame notification of which is provided in Capabilities Exchange is similar to the configuration illustrated in FIG. 7, but Further-enhanced directional multi gigabit (FE-DMG) Capabilities element includes information indicating propriety of performing subsequent E-MIMO Beamforming.

In a case where a terminal (the access point AP or the communication terminal STA) notified of the frame is notified that SISO Beamforming, MIMO Beamforming, and MIMO Beamforming can be performed in E-MIMO Capabilities and has provided notification that the self can also similarly perform those in the frame, SISO Beamforming, MIMO Beamforming, and E-MIMO Beamforming may be performed with the terminal (the communication terminal STA or the access point AP) that has provided notification of the frame as a destination.

(S22: SISO Beamforming)

In step S22 of FIG. 14, SISO Beamforming is performed similarly to step S12 of FIG. 6, but the description thereof will be omitted here because the description will be redundant.

(S23: MIMO Beamforming)

In step S23 of FIG. 14, MIMO Beamforming is performed similarly to step S13 of FIG. 6.

However, in the E-BRP frame to be transmitted, F-EDMG TRN-Unit B-N in F-EDMG Header in F-EDMG Header in PHY Header includes information indicating that transmission is not performed with a delay time vector applied, and similarly, a known sequence is generated without a delay time vector being applied, also in each TRN in a subsequent TRN field.

By this MIMO Beamforming, among the combinations of the DMG antenna set and the AWV, the access point AP and the communication terminal STA determine one or more combinations considered to be optimum in downlink (a transmission link when the access point AP transmits and the communication terminal STA receives) and uplink (a link when the communication terminal STA transmits and the access point AP receives).

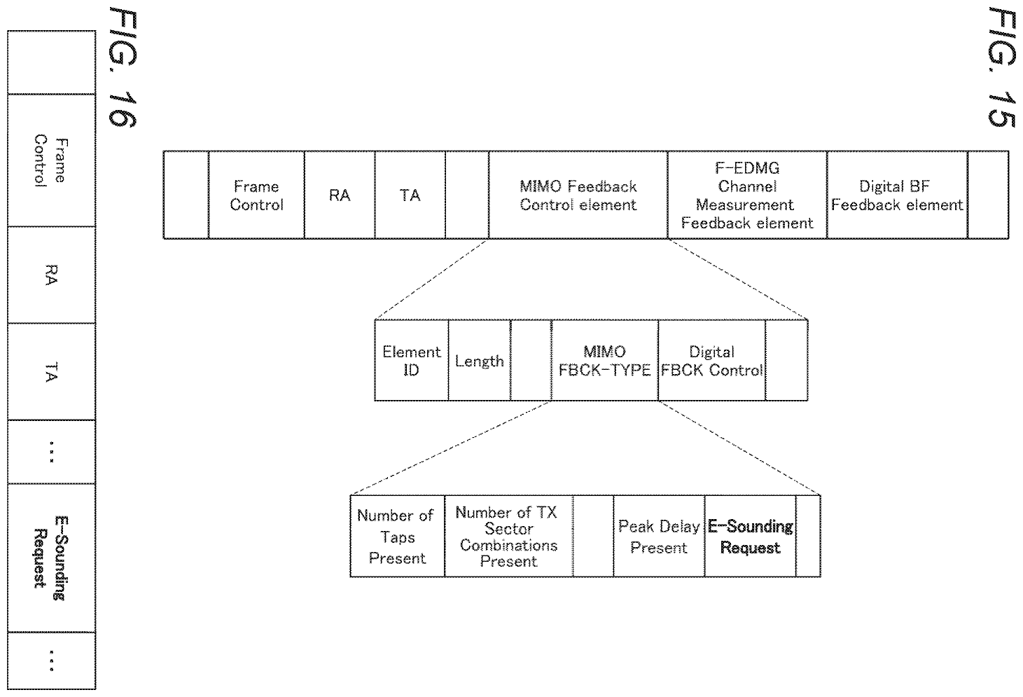

In a case where E-MIMO Beamforming Request is also performed in Enhanced-MIMO BF Feedback (corresponding to S13-3 in FIG. 6) in MIMO Beamforming (S23) as described later, a frame illustrated in FIG. 15 may be used.

As illustrated in FIG. 15, a frame notification of which is provided in Enhanced-MIMO BF Feedback corresponds to the configuration example of the frame illustrated in FIGS. 12 and 13, but MIMO Feedback Control element is different in the components.

In FIG. 15, the MIMO Feedback Control element includes information regarding a format of subsequent F-EDMG Channel Measurement Feedback element and Digital BF Feedback element, and information indicating a request for performing E-MIMO Beamforming.

The MIMO Feedback Control element includes fields that are Element ID, Length, MIMO FBCK-TYPE, and Digital FBCK Control, and the MIMO FBCK-TYPE includes information indicating a request for performing E-MIMO Beamforming in addition to the above-described information.

That is, the MIMO FBCK TYPE includes a subfield that is E-Sounding Request, in addition to Number of Taps Present, Number of TX Sector Combinations Present, and Peak Delay Present. The E-Sounding Request includes information indicating a request for performing E-MIMO Beamforming.

(S24: E-MIMO Beamforming)

The access point AP and the communication terminal STA that have performed MIMO Beamforming (S23) perform information notification (E-MIMO Beamforming) for determining an optimum delay time vector for the combination of the DMG antenna set and the AWV defined in MIMO Beamforming (S24).

E-MIMO Beamforming (S24) is roughly sectioned into three steps of Enhanced-MIMO BF Setup (S24-1 and S24-2), Beam Training (S24-3), and Enhanced-MIMO BF Feedback (S24-4). Enhanced-MIMO BF Setup includes two sub-steps: Enhanced-MIMO BF Request and Enhanced-MIMO BF Announcement.

In FIG. 14, Enhanced-MIMO BF Request and Enhanced-MIMO BF Feedback are performed from the communication terminal STA to the access point AP, and Enhanced-MIMO BF Announcement and Beam Training are performed from the access point AP to the communication terminal STA in the illustrated case, but they may be reversed. That is, Enhanced-MIMO BF Request and Enhanced-MIMO BF Feedback may be performed from the access point AP to the communication terminal STA, and Enhanced-MIMO BF Announcement and Beam Training may be performed from the communication terminal STA to the access point AP.

(S24-1: Enhanced-MIMO BF Request)

The access point AP and the communication terminal STA that have performed MIMO Beamforming (S23) perform request for performing E-MIMO Beamforming (E-MIMO Beamforming Request) (S24-1).

Note that, as described above, in a case where similar notification is performed in Enhanced-MIMO BF Feedback in MIMO Beamforming, it is not necessary to perform Enhanced-MIMO BF Request in E-MIMO Beamforming.

FIG. 16 illustrates a configuration example of a frame notification of which is provided in Enhanced-MIMO BF Request.

This frame includes Frame Control, RA, TA, and E-Sounding Request. However, the components of the frame are not limited thereto.

The Frame Control includes information indicating that the frame is a frame notification of which is provided in Enhanced-MIMO BF Request. The RA and the TA respectively include information indicating a destination terminal and a transmission source terminal.

The E-Sounding Request includes information indicating a request for performing subsequent Beam Training in E-MIMO Beamforming.

(S24-2: Enhanced-MIMO BF Announcement)

When a terminal (the communication terminal STA or the access point AP) is notified of a request for performing Beam Training in Enhanced-MIMO BF Request (S24-1) and determines to perform Beam Training in E-MIMO Beamforming, the terminal performs notification (Enhanced-MIMO BF Announcement) of performing Beam Training in E-MIMO Beamforming (S24-2).

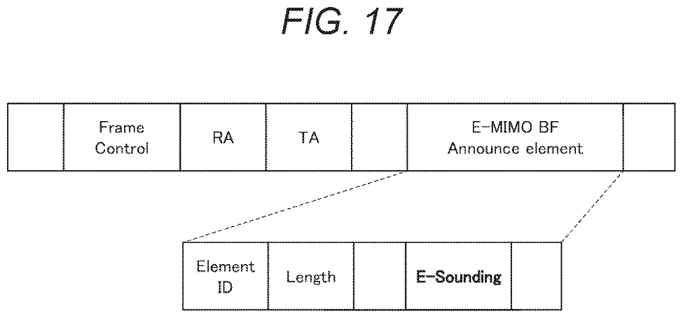

FIG. 17 illustrates a configuration example of a frame notification of which is provided in Enhanced-MIMO BF Announcement.

This frame includes Frame Control, RA, TA, and E-MIMO BF Announcement element. However, the components of the frame are not limited thereto.

The Frame Control includes information indicating that the frame is a frame notification of which is provided in Enhanced-MIMO BF Announcement. The RA and the TA respectively include information indicating a destination terminal and a transmission source terminal.

The E-MIMO BF Announcement element includes information regarding performing of E-MIMO Beamforming. The E-MIMO BF Announcement element includes fields that are Element ID, Length, and E-Sounding.

The Element ID includes information indicating that the element is the E-MIMO BF Announcement element. The Length includes information indicating a bit length of the E-MIMO BF Announcement element.

The E-Sounding includes information indicating whether or not subsequent Beam Training is performed in E-MIMO Beamforming.

Note that the frame may be transmitted as a Grant frame or an RTS frame described in Document 4 described above.

(S24-3: Beam Training)

In step S24-3 of FIG. 14, Beam Training is performed similarly to step S13-2 of FIG. 6.

However, in the E-BRP frame to be transmitted (FIG. 9), the Frame Control includes information indicating that notification of the frame is provided in Beam Training in E-MIMO Beamforming, and different delay vectors are applied in the TRN field in the frame to be transmitted in Beam Training. That is, the F-EDMG TRN Unit B-N in the F-EDMG Header in the PHY Header indicates that a plurality of delay vectors is used in TRN.

(S24-4: E-MIMO BF Feedback)

In step S24-4 of FIG. 14, Enhanced-MIMO BF Feedback is performed similarly to step S13-3 of FIG. 6.

However, the Frame Control includes information indicating that notification of the frame is provided in Enhanced-MIMO BF Feedback in E-MIMO Beamforming.

Furthermore, in the second embodiment, in the frame to be transmitted (FIG. 12, FIG. 13), a step for determining a delay time vector is performed on the basis of a result obtained in MIMO Beamforming, and the responder side does not need to estimate channel quality with a resolution equal to or more than a prescribed sample. Therefore, processing can be expected to be shortened as compared with the first embodiment, and it is possible to improve ease of performing on the responder side.

In the communication device 10 that performs such processing as described above, the following processing is performed by at least one control unit out of the control unit 100 and the wireless control unit 110.

That is, in a first communication device 10 (for example, the communication terminal STA) including one or more antennas, a propagation path with a second communication device 10 is estimated on the basis of a reference signal (for example, the E-BRP frame in FIG. 9) transmitted from the second communication device 10 (for example, the access point AP) including one or more antennas, fourth information (for example, the E-Sounding Request in FIG. 15) is generated indicating a request for transmitting a reference signal obtained by computing a delay time vector that is any minute delay time difference computed in each antenna in the antenna included in the second communication device 10, and the generated fourth information is transmitted to the second communication device 10.

In this first communication device 10 (for example, the communication terminal STA), fifth information is generated indicating that the fourth information can be generated and transmitted to another communication device 10, and the generated fifth information (for example, the FE-DMG Capabilities element in FIG. 7) is transmitted to the second communication device 10.

Furthermore, in a third communication device 10 (for example, the access point AP) including one or more antennas, a propagation path is estimated on the basis of a reference signal transmitted from a fourth communication device 10 (for example, the communication terminal STA) including one or more antennas, ninth information (for example, the E-Sounding Request in FIGS. 15 and 16) is generated indicating a request, to the fourth communication device 10, for transmitting a reference signal including one or more reference signal elements to the third communication device 10, on the basis of information regarding the propagation path and a threshold value, and the generated ninth information is transmitted to the fourth communication device 10. As the ninth information, tenth information (for example, the E-Sounding Request in FIG. 15) including information regarding the propagation path is generated.

### 3. Modified Example

Note that the series of processing of the communication device 10 described above can be executed by hardware or software. In a case where the series of processing is executed by software, a program constituting the software is installed in a computer of each device.

Furthermore, the embodiments of the present technology are not limited to the above-described embodiments, and various modifications can be made without departing from the scope of the present technology.

Moreover, each step described in the above-described entire sequence can be executed by one device or can be shared and executed by a plurality of devices. Moreover, in a case where one step includes a plurality of processes, the plurality of processes included in the one step can be executed by one device, and also shared and executed by a plurality of devices.

Note that, in the present specification, the system means a set of a plurality of components (a device, a module (a part), and the like), and it does not matter whether or not all the components are in the same housing. Therefore, a plurality of devices housed in separate housings and connected via a network, and a single device with a plurality of modules housed in one housing are both systems.

Furthermore, the effects described in this specification are merely examples and are not limited, and other effects may be present.

Furthermore, the present technology can have the following configurations.

(1)

A communication device that is a first communication device including one or more antennas, the communication device including

a control unit configured to perform control of:

generating first information on the basis of a reference signal transmitted from a second communication device including one or more antennas, the first information including information regarding an arrival time of the reference signal and information indicating that information regarding the arrival time is included, for each combination of the antennas included in the first communication device and the second communication device; and

transmitting the generated first information to the second communication device.

(2)

The communication device according to (1) above, in which

the control unit

generates second information indicating that the first information can be generated and transmitted to another communication device, and

transmits the generated second information to the second communication device.

(3)

The communication device according to (1) or (2) above, in which

the control unit

generates the first information on the basis of third information after the second communication device transmits the reference signal, notification of the third information being provided from the second communication device and requesting that the first communication device provides notification of the first information after the second communication device transmits the reference signal, and

transmits the generated first information to the second communication device.

(4)

The communication device according to any one of (1) to (3), in which

the control unit generates the first information including information regarding an arrival time of the reference signal with a resolution equal to or more than a sample time.

(5)

The communication device according to (2) above, in which

the first information is included in a first frame notification of which is provided in a first phase, and

the second information is included in a second frame notification of which is provided in a second phase performed temporally before the first phase.

(6)

The communication device according to any one of (1) to (5), further including:

a communication unit configured to transmit the first information to the second communication device by wireless communication.

(7)

The communication device according to any one of (1) to (6), in which

the first communication device is a communication terminal, and

the second communication device is an access point.

(8)

A communication device that is a first communication device including one or more antennas, the communication device including:

a control unit configured to perform control of:

estimating a propagation path with a second communication device on the basis of a reference signal transmitted from the second communication device including one or more antennas, and generating fourth information indicating a request for transmitting the reference signal obtained by computing a delay time vector in each of the antennas of the second communication device, the delay time vector being any minute delay time difference computed by each of the antennas; and

transmitting the generated fourth information to the second communication device.

(9)

The communication device according to (8) above, in which

the control unit

generates fifth information indicating that the fourth information can be generated and transmitted to another communication device, and

transmits the generated fifth information to the second communication device.

(10)

The communication device according to (9) above, in which

the fourth information is included in a fourth frame notification of which is provided in a fourth phase, and

the fifth information is included in a fifth frame notification of which is provided in a fifth phase performed temporally before the fourth phase.

(11)

The communication device according to any one of (8) to (10) above, further including:

a communication unit configured to transmit the fourth information to the second communication device by wireless communication.

(12)

The communication device according to any one of (8) to (11), in which

the first communication device is a communication terminal, and

the second communication device is an access point.

(13)

A communication device that is a third communication device including one or more antennas, the communication device including

a control unit configured to perform control of:

transmitting, to a fourth communication device including one or more antennas, a reference signal including one or more reference signal elements with respect to a reference signal element generated on the basis of a delay time vector.

(14)

The communication device according to (13) above, in which

the control unit

generates sixth information indicating a number of patterns of the delay time vector used to generate the reference signal element, for one or more of the reference signal elements included in the reference signal, and

transmits the generated sixth information to the fourth communication device.

(15)

The communication device according to (13) or (14) above, in which

the control unit

generates seventh information on the basis of eighth information after the fourth communication device transmits the reference signal, notification of the eighth information being provided from the fourth communication device and requesting that the third communication device provides notification of the seventh information, the seventh information including information regarding an arrival time of the reference signal and information indicating that information regarding the arrival time is included, for each combination of the antennas included in the third communication device and the fourth communication device after the fourth communication device transmits the reference signal, and

transmits the generated seventh information to the fourth communication device.

(16)

The communication device according to any one of (13) to (15), in which

the control unit

estimates a propagation path on the basis of the reference signal transmitted from the fourth communication device, and generates ninth information indicating a request, to the fourth communication device, for transmitting the reference signal including one or more reference signal elements to the third communication device, on the basis of information regarding the propagation path and a threshold value, and

transmits the generated ninth information to the fourth communication device.

(17)

The communication device according to (16) above, in which

the control unit

generates, as the ninth information, tenth information including information regarding the propagation path, and

transmits the generated tenth information to the fourth communication device.

(18)

The communication device according to any one of (13) to (17), in which

the control unit

generates eleventh information indicating that it is possible to transmit the reference signal including one or more reference signal elements, with respect to a reference signal element generated on the basis of a delay time vector, and

transmits the generated eleventh information to the fourth communication device.

(19)

The communication device according to any one of (13) to (18), further including:

a communication unit configured to transmit the reference signal to the fourth communication device by wireless communication.

(20)

The communication device according to any one of (13) to (19), in which

the third communication device is an access point or a communication terminal, and

the fourth communication device is a communication terminal or an access point.

### REFERENCE SIGNS LIST

10 Communication device
100 Control unit
101 Communication unit
102 Power supply unit
110 Wireless control unit
111 Data processing unit
112 Modulation/demodulation unit
113, 113-1, 113-2 Signal processing unit
114 Channel estimation unit
115, 115-1, 115-2 Additional delay compensation unit
116, 116-1, 116-2 Wireless interface unit
117, 117-1, 117-2 Amplifier unit
118, 118-1, 118-2 Phase shifter unit
119 SW unit
120, 120-1 to 120-N Antenna unit

1. A communication device that includes a first communication device including one or more antennas, the communication device comprising
a control unit configured to perform control of:
generating first information on a basis of a reference signal transmitted from a second communication device including one or more antennas, the first information including information regarding an arrival time of the reference signal and information indicating that information regarding the arrival time is included, for each combination of the antennas included in the first communication device and the second communication device; and
transmitting the generated first information to the second communication device.

2. The communication device according to claim 1, wherein
the control unit
generates second information indicating that the first information can be generated and transmitted to another communication device, and
transmits the generated second information to the second communication device.

3. The communication device according to claim 1, wherein
the control unit
generates the first information on a basis of third information after the second communication device transmits the reference signal, notification of the third information being provided from the second communication device and requesting that the first communication device provides notification of the first information after the second communication device transmits the reference signal, and
transmits the generated first information to the second communication device.

4. The communication device according to claim 1, wherein
the control unit generates the first information including information regarding an arrival time of the reference signal with a resolution equal to or more than a sample time.

5. The communication device according to claim 2, wherein
the first information is included in a first frame notification of which is provided in a first phase, and
the second information is included in a second frame notification of which is provided in a second phase performed temporally before the first phase.

6. The communication device according to claim 1, further comprising:
a communication unit configured to transmit the first information to the second communication device by wireless communication.

7. The communication device according to claim 1, wherein
the first communication device includes a communication terminal, and
the second communication device includes an access point.

8. A communication device that includes a first communication device including one or more antennas, the communication device comprising:
a control unit configured to perform control of:
estimating a propagation path with a second communication device on a basis of a reference signal transmitted from the second communication device including one or more antennas, and generating fourth information indicating a request for transmitting the reference signal obtained by computing a delay time vector in each of the antennas of the second communication device, the delay time vector being any minute delay time difference computed by each of the antennas; and
transmitting the generated fourth information to the second communication device.

9. The communication device according to claim 8, wherein
the control unit
generates fifth information indicating that the fourth information can be generated and transmitted to another communication device, and
transmits the generated fifth information to the second communication device.

10. The communication device according to claim 9, wherein
the fourth information is included in a fourth frame notification of which is provided in a fourth phase, and
the fifth information is included in a fifth frame notification of which is provided in a fifth phase performed temporally before the fourth phase.

11. The communication device according to claim 8, further comprising:
a communication unit configured to transmit the fourth information to the second communication device by wireless communication.

12. The communication device according to claim 8, wherein
the first communication device includes a communication terminal, and
the second communication device includes an access point.

13. A communication device that includes a third communication device including one or more antennas, the communication device comprising
a control unit configured to perform control of:
transmitting, to a fourth communication device including one or more antennas, a reference signal including one or more reference signal elements with respect to a reference signal element generated on a basis of a delay time vector.

14. The communication device according to claim 13, wherein
the control unit
generates sixth information indicating a number of patterns of the delay time vector used to generate the reference signal element, for one or more of the reference signal elements included in the reference signal, and
transmits the generated sixth information to the fourth communication device.

15. The communication device according to claim 13, wherein
the control unit
generates seventh information on a basis of eighth information after the fourth communication device transmits the reference signal, notification of the eighth information being provided from the fourth communication device and requesting that the third communication device provides notification of the seventh information, the seventh information including information regarding an arrival time of the reference signal and information indicating that information regarding the arrival time is included, for each combination of the antennas included in the third communication device and the fourth communication device after the fourth communication device transmits the reference signal, and
transmits the generated seventh information to the fourth communication device.

16. The communication device according to claim 13, wherein
the control unit
estimates a propagation path on a basis of the reference signal transmitted from the fourth communication device, and generates ninth information indicating a request, to the fourth communication device, for transmitting the reference signal including one or more reference signal elements to the third communication device, on a basis of information regarding the propagation path and a threshold value, and
transmits the generated ninth information to the fourth communication device.

17. The communication device according to claim 16, wherein
the control unit
generates, as the ninth information, tenth information including information regarding the propagation path, and
transmits the generated tenth information to the fourth communication device.

18. The communication device according to claim 13, wherein
the control unit
generates eleventh information indicating that it is possible to transmit the reference signal including one or more reference signal elements, with respect to a reference signal element generated on a basis of a delay time vector, and
transmits the generated eleventh information to the fourth communication device.

19. The communication device according to claim 13, further comprising:
a communication unit configured to transmit the reference signal to the fourth communication device by wireless communication.

20. The communication device according to claim 13, wherein
the third communication device includes an access point or a communication terminal, and
the fourth communication device includes a communication terminal or an access point.
